(19) United States
(12) Patent Application Publication
(10) Pub. No.: US 2026/0261521 A1
(43) Pub. Date: Sep. 3, 2026

(54) INFORMATION PROCESSING METHOD AND APPARATUS, AND COMMUNICATION DEVICE AND STORAGE MEDIUM

(71) Applicant: Beijing Xiaomi Mobile Software Co., Ltd., Beijing (CN)

(72) Inventors: Jinhua WU, Beijing (CN); Yang SHEN, Beijing (CN)

(73) Assignee: Beijing Xiaomi Mobile Software Co., Ltd., Beijing (CN)

(21) Appl. No.: 19/164,652

(22) PCT Filed: Mar. 22, 2023
(86) PCT No.: PCT/CN2023/083212

§ 371 Date: Sep. 12, 2025

(51) Int. Cl. H04L 47/32

(52) U.S. Cl. CPC H04L 47/32

(57) ABSTRACT

An information processing method, which is executed by an RAN node, may comprise: determining the discard situation of a PDU set; and according to the discard situation, sending to a UPF discard information of the PDU set, wherein the discard information indicates discard usage of the PDU set.

### CROSS-REFERENCE TO RELATED APPLICATIONS

The present application is a U.S. National Stage of International Application No. PCT/CN2023/083212, filed on Mar. 22 2023, the disclosure of which is incorporated herein by reference in its entirety for all purposes.

### TECHNICAL FIELD

The present disclosure relates to, but is not limited to, the field of wireless communication technologies, and in particular to an information processing method and apparatus, a communication device, and a storage medium.

### BACKGROUND

Services such as mobile media services, extended Reality (XR) services such as cloud Augmented Reality (AR) or Virtual Reality (VR), cloud gaming, and video-based remote control of machines or drones are expected to contribute increasingly higher traffic to the network.

The XR services involve multimodal data. The multimodal data may include data in multiple modes. For example, in addition to audio and/or video, it may also involve data in other modalities such as biological tactile perception data.

In some transmission scenarios, multimodal data streams may belong to the same service or application, and multiple data streams of these multimodal data may come from input data of one or more devices, or may come from output data of one or more devices.

The data streams in the multimodal data often have certain or even strong correlations, such as the association of synchronous playback or synchronous acquisition of audio streams and video streams, or the association of synchronous output of tactile data streams and visual video streams.

Such association renders that multiple data flows belonging to the same service or application or multiple data flows belonging to multimodal data have different Quality of Service (QoS) requirements than those for non-multimodal data during transmission.

### SUMMARY

Embodiments of the present disclosure provide a method and apparatus, a communication device, and a storage medium.

A first aspect of embodiments of the present disclosure provides an information processing method, the method is performed by a Radio Access Network (RAN) node, and the method includes:
determining a discard situation of a Protocol Data Protocol (PDU) set; and
sending, according to the discard situation, discard information of the PDU set to a User Plane Function (UPF), where the discard information indicates a discard usage of the PDU set.

A second aspect of the embodiments of the present disclosure provides an information processing method, the method is performed by a UPF, and the method includes:
receiving discard information sent by an RAN node; where the discard information indicates a discard usage of a PDU set; and
correcting, according to discard information, a usage of a Quality of Service (QOS) flow to which the PDU set belongs.

A third aspect of the embodiments of the present disclosure provides an information processing method, the method is performed by a Session Management Function (SMF), and the method includes:
receiving a Policy and Charging Control (PCC) rule sent by a Policy Control Function (PCF); and
sending, according to the PCC rule, a PDU set QoS parameter and/or correction indication to a Radio Access Network (RAN) node, where the PDU set QoS parameter and/or correction indication is used by the RAN node to perform an operation related to a discard usage of a PDU set.

A fourth aspect of the embodiments of the present disclosure provides an information processing method, the method is performed by a Policy Control Function (PCF), and the method includes:
sending a Policy and Charging Control (PCC) rule to a SMF; where the PCC rule is used for the SMF to determine a PDU set QoS parameter, and the PDU set QoS parameter is used by the RAN node to perform an operation related to a discard usage of a PDU set.

A fifth aspect of the embodiments of the present disclosure provides an information processing method, the method is performed by an Application Function (AF), and the method includes:
sending flow information to a PCF; where the flow information is used by the PCF to generate a PCC rule or correction indication; where the PCC rule is used by a SMF to generate a PDU set QOS parameter; and the PDU set QoS parameter or the correction indication is used by a RAN node to perform an operation related to a discard usage of a PDU set.

A sixth aspect of the embodiments of the present disclosure provides an information processing method, the method is performed by an Application Function (AF), and the method includes:
sending a service data flow to a UPF; where the service data flow includes PDU set information, and/or the service data flow includes flow information used for determining the PDU set information; and where the PDU set information is used by a Radio Access Network (RAN) node to perform an operation related to a discard usage of a PDU set.

A seventh aspect of the embodiments of the present disclosure provides an information processing method, including:
determining, by an RAN node, a discard situation of a PDU set; and sending, by the RAN node according to the discard situation, discard information of the PDU set to a User Plane Function (UPF), where the discard information indicates a discard usage of the PDU set; and
receiving, by the UPF, the discard information and correcting, by the UPF according to the discard information, a usage of a Quality of Service (QoS) flow to which the PDU set belongs.

An eighth aspect of the embodiments of the present disclosure provides an information processing apparatus, the apparatus including:
a determination module, configured to determine a discard situation of a PDU set; and
a first sending module, configured to send discard information of the PDU set to a UPF according to the discard situation, where the discard information indicates a discard usage of the PDU set.

A ninth aspect of the embodiments of the present disclosure provides an information processing apparatus, and the apparatus includes:
a first receiving module, configured to receive discard information sent by an RAN node; where the discard information indicates a discard usage of a PDU set; and
a correction module, configured to correct a usage of a QoS flow to which the PDU set belongs according to the discard information.

A tenth aspect of the embodiments of the present disclosure provides an information processing apparatus, and the apparatus includes:
a second receiving module, configured to receive a Policy and Charging Control (PCC) rule sent by a Policy Control Function (PCF); and
a second sending module, configured to send a PDU set Quality of Service (QOS) parameter and/or correction indication to a Radio Access Network (RAN) node according to the PCC rule, where the PDU set QoS parameter and/or the correction indication is used by the RAN node to perform an operation related to a discard usage of the PDU set.

An eleventh aspect of the embodiments of the present disclosure provides an information processing apparatus, and the apparatus includes:
a third sending module, configured to send a Policy and Charging Control (PCC) rule to a Session Management Function (SMF); where the PCC rule is used by the SMF to determine a Protocol Data Unit (PDU) set Quality of Service (QoS) parameter; and the PDU set QoS parameter is used by the RAN node to perform an operation related to a discard usage of the PDU set.

A twelfth aspect of the embodiments of the present disclosure provides an information processing apparatus, and the apparatus includes:
a fourth sending module, configured to send flow information to a Policy Control Function (PCF); where the flow information is used by the Policy Control Function (PCF) to generate a PCC rule or correction indication; the PCC rule used for the PCC rule is used by a Session Management Function (SMF) to generate a Protocol Data Unit (PDU) set Quality of Service (QoS) parameter; and the PDU set QoS parameter or the correction indication is used by a Radio Access Network (RAN) node to perform an operation related to a discard usage of the PDU set.

A thirteenth aspect of the embodiments of the present disclosure provides an information processing apparatus, and the apparatus includes:
a fifth sending module, configured to send a service data flow to a User Plane Function (UPF); where the service data flow includes Protocol Data Unit (PDU) set information, and/or the service data flow includes flow information for determining the PDU set information; and the PDU set information is used by a Radio Access Network (RAN) node to perform an operation related to a discard usage of a PDU set.

A fourteenth aspect of the embodiments of the present disclosure provides a communication device, including a processor, a transceiver, a memory, and an executable program that is stored in the memory and can be run by the processor, and when the processor runs the executable program, the information processing method provided in any of the first to seventh aspects mentioned above is performed.

A fifteenth aspect of the embodiments of the present disclosure provides a computer storage medium having stored an executable program; and after the executable program is executed by a processor, it can implement the information processing method provided in any of the first to seventh aspects mentioned above.

A sixteenth aspect of the embodiments of the present disclosure provides a wireless communication system, including:
an RAN node, configured to at least determine a discard situation of a protocol data unit (PDU) set, and send discard information of the PDU set to a User Plane Function (UPF) according to the discard situation, where the discard information indicates a discard usage of the PDU set; and
the UPF, configured to receive the discard information and correct, according to the discard information, a usage of a Quality of Service (QoS) flow to which the PDU set belongs.

In the technical solutions provided by the embodiments of the present disclosure, it should be understood that the above general description and the following detailed description are merely illustrative and explanatory and cannot limit the embodiments of the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the embodiments of the present disclosure.

FIG. 1 is a schematic structural diagram of a wireless communication system according to an illustrative embodiment;

FIG. 2A is a schematic flow chart showing an information processing method according to an illustrative embodiment;

FIG. 2B is a schematic flow chart showing an information processing method according to an illustrative embodiment;

FIG. 2C is a schematic flow chart showing an information processing method according to an illustrative embodiment;

FIG. 2D is a schematic flow chart showing an information processing method according to an illustrative embodiment;

FIG. 2E is a schematic flow chart showing an information processing method according to an illustrative embodiment;

FIG. 2F is a schematic flow chart showing an information processing method according to an illustrative embodiment;

FIG. 2G is a schematic flow chart showing an information processing method according to an illustrative embodiment;

FIG. 2H is a schematic flow chart showing an information processing method according to an illustrative embodiment;

FIG. 3A is a schematic flow chart showing an information processing method according to an illustrative embodiment;

FIG. 3B is a schematic flow chart showing an information processing method according to an illustrative embodiment;

FIG. 3C is a schematic flow chart showing an information processing method according to an illustrative embodiment;

FIG. 3D is a schematic flow chart showing an information processing method according to an illustrative embodiment;

FIG. 3E is a schematic flow chart showing an information processing method according to an illustrative embodiment;

FIG. 4 is a schematic flow chart showing an information processing method according to an illustrative embodiment;

FIG. 5A is a schematic flow chart showing an information processing method according to an illustrative embodiment;

FIG. 5B is a schematic flow chart showing an information processing method according to an illustrative embodiment;

FIG. 6A is a schematic flow chart showing an information processing method according to an illustrative embodiment;

FIG. 6B is a schematic flow chart showing an information processing method according to an illustrative embodiment;

FIG. 7 is a schematic flow chart showing an information processing method according to an illustrative embodiment;

FIG. 8 is a schematic flow chart showing an information processing method according to an illustrative embodiment;

FIG. 9A is a schematic flow chart showing an information processing method according to an illustrative embodiment;

FIG. 9B is a schematic flow chart showing an information processing method according to an illustrative embodiment;

FIG. 9C is a schematic flow chart showing an information processing method according to an illustrative embodiment;

FIG. 9D is a schematic flow chart showing an information processing method according to an illustrative embodiment;

FIG. 10A is a schematic flow chart showing an information processing method according to an illustrative embodiment;

FIG. 10B is a schematic flow chart showing an information processing method according to an illustrative embodiment;

FIG. 11 is a schematic structural diagram showing an information processing apparatus according to an illustrative embodiment;

FIG. 12 is a schematic structural diagram showing an information processing apparatus according to an illustrative embodiment;

FIG. 13 is a schematic structural diagram showing an information processing apparatus according to an illustrative embodiment;

FIG. 14 is a schematic structural diagram showing an information processing apparatus according to an illustrative embodiment;

FIG. 15 is a schematic structural diagram showing an information processing apparatus according to an illustrative embodiment;

FIG. 16 is a schematic structural diagram showing an information processing apparatus according to an illustrative embodiment; and FIG. 17 is a schematic structural diagram showing a communication device according to an illustrative embodiment.

### DETAILED DESCRIPTION

Illustrative embodiments will be described in detail herein, with examples thereof illustrated in the accompanying drawings. In the following description, when referring to the drawings, identical numerals in different figures represent identical or similar elements, unless otherwise indicated. The implementations described in the following illustrative embodiments are not intended to represent all possible implementations consistent with the present disclosure. Rather, they are merely examples of apparatuses and methods consistent with certain aspects of the present disclosure.

The terms used in the embodiments of the present disclosure are for the purpose of describing specific embodiments only and are not intended to limit the embodiments of the present disclosure. The singular forms “a (an)” “said” and “the” used in the present disclosure are also intended to include the plural forms unless the context clearly indicates otherwise. It should also be understood that the term “and/or” used herein refers to and includes any or all possible combinations of one or more associated listed items.

It should be understood that although the terms first, second, third, etc. may be used to describe various information in the embodiments of the present disclosure, such information should not be limited to these terms. These terms are only used to distinguish information of the same type from each other. For example, without departing from the scope of the embodiments of the present disclosure, the first information may also be referred to as the second information, and similarly, the second information may also be referred to as the first information. Depending on the context, the word “if” as used herein may be interpreted as “at the time of” or “when” or “in response to determining”.

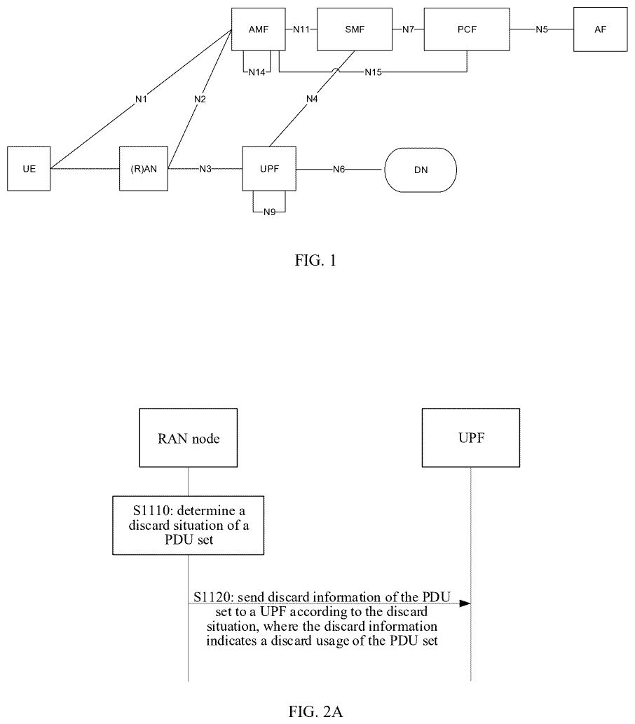

Referring to FIG. 1, FIG. 1 shows a schematic structural diagram of a wireless communication system provided by an embodiment of the present disclosure. As shown in FIG. 1, the wireless communication system is a communication system based on cellular mobile communication technology, and the wireless communication system may include: one or more UEs, one or more access network nodes, and one or more Core Network (CN) nodes. As shown in FIG. 1, the wireless communication system may also include a Data Network. In FIG. 1, N1 to N15 all represent communication interfaces between different network nodes. For example, the AMF and RAN nodes communicate via the N2 interface. The RAN nodes and UPF communicate via the N3 interface. The SMF and UPF communicate via the N4 interface.

In some cases, the wireless communication system may further include one or more Application Functions (AFs) or one or more Application Servers (ASs). The AFs may be deployed within or outside the core network.

The access network node belongs to an access network (AN) and may include one or more base stations or other devices connected to the base station.

For example, the UE can communicate with one or more core networks via a Radio Access Network (RAN). The UE can be an IoT UE, such as a sensor device, a mobile phone (also known as a “cellular” phone), and a computer with an IoT UE. For example, the UE can be a fixed, portable, pocket-sized, handheld, computer-built-in, or vehicle-mounted device, for example, a station (STA), a subscriber unit, a subscriber station, a mobile station, a mobile, a remote station, an access point, a remote terminal, an access terminal, a user terminal, a user agent, a user device, or a user equipment (UE). Alternatively, the UE can be a device on an unmanned aerial vehicle. Alternatively, the UE can be a vehicle-mounted device, such as a driving computer with wireless communication capabilities, or a wireless communication device connected to an external driving computer. Alternatively, the UE can be a roadside device, such as a streetlight, traffic light, or other roadside device with wireless communication capabilities.

The access network node may include radio access network nodes and non-radio access network nodes. For example, the access network node may be a network-side device in a wireless communication system. The wireless communication system may be a fourth-generation mobile communication (4G) system, also known as a Long Term Evolution (LTE) system; or the wireless communication system may be a 5G system, also known as a New Radio (NR) system or a 5G NR system. Alternatively, the wireless communication system may be a next-generation system of the 5G system. The access network in the 5G system may be called an NG-RAN (New Generation-Radio Access Network), or an MTC system.

The access network node may be an evolved access device (eNB) used in 4G systems. Alternatively, the access network node can be an access device (gNB) using a centralized distributed architecture in 5G systems. When the access network node adopts the centralized distributed architecture, it typically includes a central unit (CU) and at least two distributed units (DUs). The central unit is provided with protocol stacks of a Packet Data Convergence Protocol (PDCP) layer, a Radio Link Control Protocol (RLC) layer, and a Media Access Control (MAC) layer; and the distributed unit is provided with a physical (PHY) layer protocol stack. The specific implementation of the access network node is not limited in the embodiments of the present disclosure.

A wireless connection can be established between the access network node and the UE via a radio air interface. In varying implementations, the radio air interface can be a radio air interface based on the fourth-generation mobile communication network technology (4G) standard; or, the radio air interface can be a wireless air interface based on the fifth-generation mobile communication network technology (5G) standard, e.g., a new radio interface; or the radio air interface can be a radio air interface based on a next-generation mobile communication network technology standard of 5G.

The CN node shown in FIG. 1 may include core network functions such as Access Management Function (AMF), Policy Control Function (PCF), User Plane Function (UPF), and Session Management Function (SMF).

The AMF can be used in mobility management, such as initial registration and/or registration update of UEs. The PCF can be used to formulate traffic and charging management policies. The SMF can be used to perform functions such as session establishment and/or update. The UPF can be the user plane node for data transmission within the CN.

It is worth noting that the various entities shown in FIG. 1 are examples, and the implementations or embodiments of the present disclosure may include all or part of the entities in FIG. 1, and may also include other entities beyond those in FIG. 1, and the number of the entities is arbitrary and is not limited to FIG. 1. The various connection relationships shown in FIG. 1 are examples, and any entities may be connected or disconnected, and the connection may be in any manner, either direct or indirect, wired or wireless. The association between multiple data flows of XR services or multimodal data may also be reflected in a certain dependency, which also determines the unique QoS requirements during network transmission.

For example, biometric data involved in the cloud game of the XR services is used to verify payment; and video streams and audio streams can provide visual and auditory effects of the cloud game, respectively. If the payment fails when the cloud game enters a specific interface, the audio and video streams that need to pay for cannot be played at the receiver side even if they arrive at the receiver side. If the biometric data is lost in this case, the transmission of the video and audio streams can be temporarily suspended or terminated, which is a kind of dependency relationship.

For another example, video frames in a video stream may include independent frames and dependent frames. The independent frames can be independently encoded and decoded; and the dependent frames can be encoded and decoded with reliance on the independent frames or other dependent frames. Such dependency in the encoding and decoding is also a kind of association mentioned above. As such, if the independent frame is lost, the dependent frame may not be properly encoded and decoded, and is unnecessary to be further transmitted.

To improve data transmission, a PDU set is proposed. A PDU set may include one or more PDUs. The PDUs within a PDU set may be associated with or dependent on each other; or the PDU sets may be dependent on each other. If a PDU that is depended on is discarded, further transmission of other PDUs that depend on the discarded PDU becomes meaningless and may be discarded by the RAN node. Consequently, some PDUs may be discarded, affecting the accuracy of PDU usage statistics and/or charging statistics based on accurate PDU usage statistics.

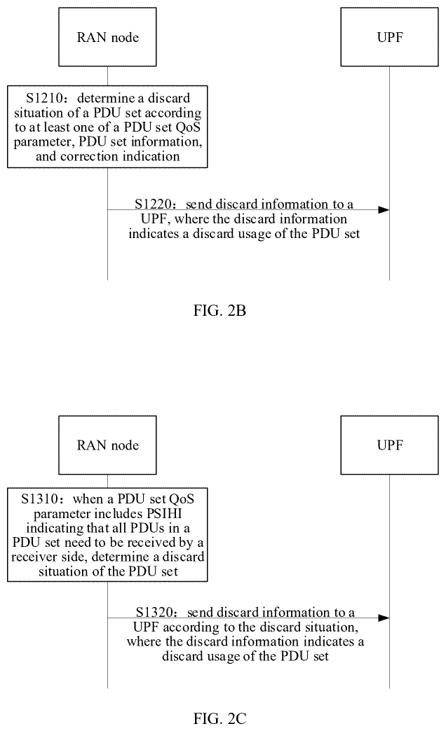

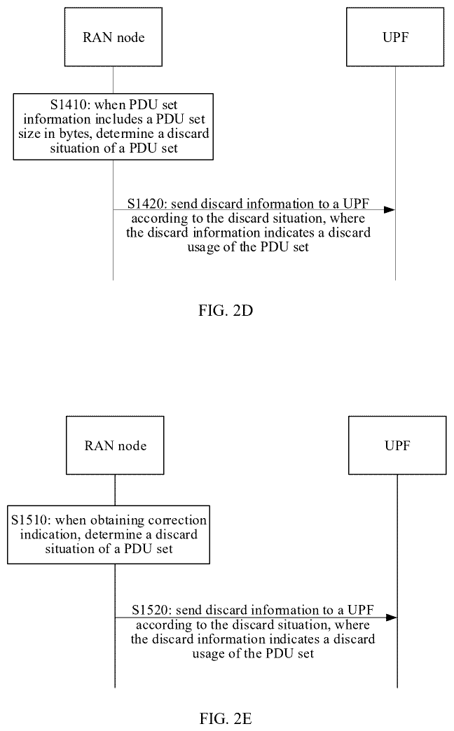

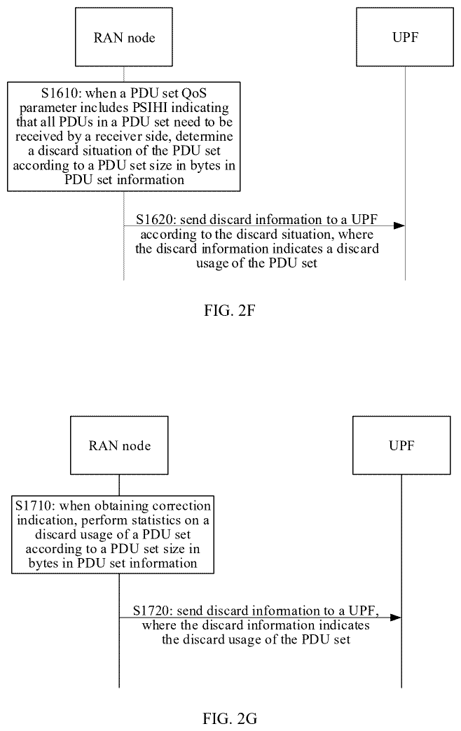

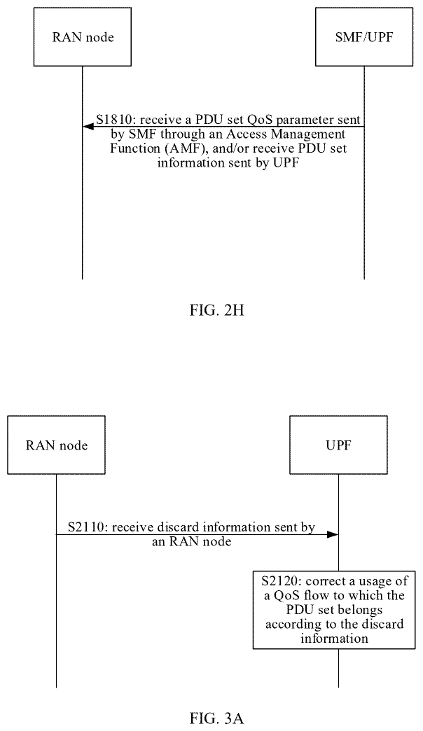

In view of this, as shown in FIG. 2A, an embodiment of the present disclosure provides an information processing method, the method is performed by an RAN node and includes:
S1110: determining a discard situation of a PDU set; and
S1120: sending discard information of the PDU set to a UPF according to the discard situation, where the discard information indicates a discard usage of the PDU set.

The radio access network node in the embodiments of the present disclosure may include the access network node as shown in FIG. 1. The access network node may be an eNB and/or a gNB. In the embodiments of the present disclosure, the functionality of the RAN node is enhanced so that the RAN node can determine the discard situation based on the PDU set.

One PDU set may include one or more PDUs. For example, the PDU set may belong to XR services or multimodal data. For example, determining the discard situation of the PDU set may include at least one of the following:
determining whether the PDU set is discarded;
determining the discard usage of the discarded PDU set, that is, determine a data volume of the discarded PDU set; or
when one or more PDU sets in the discarded PDU set are discarded, determining whether other PDUs in the discarded PDU set are discarded or have successfully arrived at a receiver side.

For example, after receiving the downlink data flow sent by the UPF, the RAN node finds that an independent PDU set or an independent PDU has been discarded. Considering that the dependent PDU set or dependent PDU cannot be independently encoded or decoded, one or more dependent PDUs or one or more dependent PDU sets can be discarded in this case, that is, they are not further transmitted to the UE, reducing the reception and encoding and decoding of the PDUs or PDU sets that the UE cannot encode or decode. However, when the network fluctuates, the RAN node may discard many PDUs for a single UE. In this case, in order to achieve better QoS control and more accurate UE traffic statistics, the RAN can perform statistics on the discard usage.

After the RAN node determines the discard situation, the RAN node may send discard information to the UPF. This discard information may directly or indirectly inform the UPF of the discard usage. The discard usage is the volume of data of the discarded PDU set. For example, the discard usage may be the volume of data of the PDU set that is not sent to the UE by the RAN node.

In short, the discard information can reflect the discard situation, that is, the discard information directly or implicitly indicates the discard usage of the PDU set. After receiving the discard information, the UPF can determine the discard usage of the PDU set.

For example, the discard information may directly be the volume of discarded data in a unit time or in a single transmission of a certain service or a certain flow.

As another example, the discard information may be a discarded downlink PDU, and the discarded downlink PDU is returned to the UPF, and the UPF may calculate the total volume of discarded data based on the downlink PDU returned by the RAN node.

Of course, those above are only examples of the RAN node sending the discard information to the UPF, and the specific implementation is not limited to the above examples.

In some embodiments, the discard usage can be used by the UPF to perform usage correction for the UE, so that the usage statistics for a single UE or a single user account are more accurate and/or the charging based on the usage statistics is more accurate. For example, the usage statistics can also be called traffic statistics.

The UPF supports various usage statistics. For example, the UPF can support usage statistics based on charging keywords or other keywords. The other keywords may include free traffic usage statistics or complimentary traffic usage statistics. The usage statistics based on the charging keywords are also called charging usage.

The SMF can perform charging based on the charging usage collected by the UPF.

For example, in the embodiments of the present disclosure, the discard information may be used at least for the UPF to correct the charging usage. In some embodiments, the RAN node may first determine whether it needs to perform statistics on the discard usage of the PDU set.

In the case where it needs to perform the statistics on the discard usage of the PDU sets, it determines the discard situation of the PDU set.

In the case where it needs not to perform the statistics on the discard usage of the PDU set, it does not determine the discard situation of the PDU set.

As shown in FIG. 2B, an embodiment of the present disclosure provides an information processing method, which is performed by an RAN node and includes:
S1210: determining a discard situation of a PDU set according to at least one of a PDU set QoS parameter, PDU set information, and correction indication; and
S1220: sending discard information to a UPF, where the discard information indicates a discard usage of the PDU set.

The PDU set QoS parameter can be used for QoS processing during PDU set transmission. For example, it can be used by the RAN node to determine the minimum guaranteed bandwidth or the maximum tolerated delay.

The PDU set information can be any information describing a corresponding PDU set. For example, the PDU set information may include: PDU set identification information and/or PDU attribute information. The attribute information may include: PDU set size, PDU set type, and/or a service type to which the PDU set belongs. The PDU set types can be categorized as an independent PDU set or a dependent PDU set. The independent PDU set can be independently encoded or decoded. The encoding and decoding of the dependent PDU set rely on other PDU sets.

The correction indication may come from a PCF, a SMF, a UPF and/or an AF, etc.

In some embodiments, the RAN node may perform statistics on the discard usage of the PDU set based solely on the PDU set QoS parameters. That is, the RAN node may determine, according to the PDU set QoS parameters by itself, whether to perform statistics on the discard usage of the PDU set without the core network node and/or AF sending the correction indication.

In some other embodiments, the RAN node may perform statistics on the discard usage of the PDU set based solely on the PDU set information. That is, the RAN node may determine, according to the PDU set QoS parameters by itself, whether to perform statistics on the discard usage of the PDU set without the core network node and/or AF sending the correction indication.

In some other embodiments, the RAN node may perform statistics on the discard usage of the PDU set based solely on the correction indication.

In some further embodiments, after receiving the correction indication, the RAN node performs statistics on the discard usage of the PDU set according to the PDU set QoS parameters and/or PDU set information.

In some further embodiments, the RAN node may perform statistics on the discard usage of the PDU set based on the combination of the PDU set QoS parameters and the PDU set information.

In the embodiments of the present disclosure, the correction indication can be used by the RAN node to determine whether to perform statistics on discard usage of the PDU set. The PDU set QoS parameters and/or PDU set information can be used by the RAN node to determine whether to perform statistics on discard usage of the PDU set, and can also be used in the statistics on discard usage of the PDU set.

In some embodiments, the PDU set QOS parameter includes at least one of the following:
PDU Set Integrated Handling Information (PSIHI), indicating whether all PDUs in the PDU set need to be received by a receiver side;
PDU Set Error Rate (PSER), indicating an upper limit of a proportion of reception failure in the PDU set; or
PDU Set Delay Budget (PSDB), indicating a difference in time of arriving at the receiver end between the first PDU and the end PDU in the PDU set.

If the PDU set QoS parameter includes the PSIHI, it can be determined based on the PSIHI whether to perform statistics on the discard usage of the PDU set. For example, if the PSIHI indicates that all PDUs in the PDU set need to be successfully received by the receiver side, in this case, if one PDU in the PDU set is lost, the RAN node will discard the entire PDU set. In this case, for a single UE or a single service, a large number of PDU discards will occur, resulting in a relatively large discard usage. Therefore, in this case, if the PDU set QoS parameter includes the PSIHI and the PSIHI indicates that all PDU sets or all PDUs in a PDU set are received by the receiver side, it is even more important to perform statistics on the discard usage of the PDU set.

In some embodiments, the PDU set QOS parameters may include the PSER. This PSER may indicate an upper limit on the proportion of reception failures. As such, if the RAN node finds that the current number of discarded PDUs has reached the upper limit, it may be possible that all the remaining PDUs or PDU sets will be discarded, and in this case, there may be a large number of PDUs being discarded. To reduce the inaccuracy of traffic statistics for a single UE, a single user, or a single service, it needs to initiate the statistics on the discard usage of the PDU set by the RAN node. This upper limit can be the upper limit on the proportion of reception failures for a single PDU set, or the upper limit on the proportion of reception failures for all PDU sets in a service transmission.

In some embodiments, if the delay for all PDUs in a PDU set to arrive at the receiver side is greater than the maximum delay indicated by the PDU set QoS parameter, that is, the actual delay is greater than the PSDB indicated by the PDU set QoS parameter, the entire PDU set can be discarded. In this case, a large number of PDUs will be discarded. In order to reduce the inaccuracy of traffic statistics for a single UE, a single user or a single service, it needs to initiate statistics on the discard usage of the PDU set by the RAN node.

Of course, the PDU set QoS parameter may include one or more of the above parameters. In some embodiments, the PDU set QoS parameters may also include a minimum guaranteed bandwidth, etc.

In some embodiments, the PDU set information includes at least one of the following:
a PDU set sequence number;
indication of an end PDU of the PDU set;
a PDU sequence number in the PDU set;
a PDU set size in bytes; or
importance information of the PDU set.

A data flow may include one or more PDU sets. These PDU sets may be numbered respectively, obtaining the PDU set sequence numbers that identify the PDU sets.

The end PDU set indication is indication of the last PDU set. For example, the end PDU set indication may include but is not limited to the sequence number of the last PDU set.

The PDU sequence number in the PDU set may include a sequence number of the first PDU and a sequence number offset. A sum of the sequence number of the first PDU set and the sequence number offset may be the sequence number of the last PDU set in the PDU set. For another example, if all PDUs in a PDU set are consecutively numbered, the sequence numbers of the PDUs in the PDU set may be indicated by the sequence number of the first PDU set and the sequence number of the end PDU. Of course, in some other embodiments, the sequence numbers of the PDUs in the PDU set are listed one by one.

The PDU set size in bytes is equivalent to clearly indicating a data volume of a PDU set, and the data volume is counted in bytes.

In some embodiments, the PDU set information includes the PDU set size in bytes. If the RAN performs PDU discarding per PDU set and can directly discard a certain PDU set, the discard usage can be directly determined based on the PDU set information without the RAN node performing statistics on the data volume for individual PDUs and determining the data volume of the entire PDU set based on the data volume of the individual PDUs, thereby simplifying the statistics on the discard usage of the PDU set by the RAN node, and thus having high compatibility with the RAN nodes in related art.

If the PDU set information includes the PDU set size in bytes, the statistics on the discard usage of the PDU set by the RAN node are simple to implement, and the RAN node can start the statistics on the discard usage of the PDU set when receiving the PDU set information including the PDU set size in bytes.

The importance information of the PDU set may be used to indicate whether the entire PDU set will be discarded when one or more PDUs in the PDU set are discarded, or whether the discarding of PDUs in the PDU set will affect the discarding of other PDU sets.

If the PDU set information received by the RAN node indicates that at least one PDU set is of high importance, the RAN node may initiate the statistics on the discard usage of the PDU set. Alternatively, if the RAN node determines based on the importance information that one or more important PDU sets have been lost, or if one or more important PDU sets are lost, the RAN node may automatically initiate the statistics on the discard usage of the PDU set.

Of course, those above are only examples of the PDU set information, and the specific implementation is not limited to the above examples.

As shown in FIG. 2C, an embodiment of the present disclosure provides an information processing method, which is performed by an RAN node and includes:
S1310: when a PDU set QoS parameter includes PSIHI indicating that all PDUs in a PDU set need to be received by a receiver side, determining a discard situation of the PDU set; and
S1320: sending discard information to a UPF according to the discard situation, where the discard information indicates a discard usage of the PDU set.

For example, the PDU set QoS parameters may come from SMF. For example, the PDU set QOS parameter forwarded by the SMF is received through the AMF, or the PDU set QoS parameter from the SMF forwarded by the UPF is received through the AMF.

In summary, the RAN node may receive the PDU set QoS parameter, and when the PDU set QoS parameter includes the PSIHI, and the RAN node determines whether to perform statistics on the discard usage of the PDU set according to the PSIHI.

As shown in FIG. 2D, an embodiment of the present disclosure provides an information processing method, which is performed by an RAN node and includes:
S1410: when PDU set information includes a PDU set size in bytes, determining a discard situation of a PDU set; and
S1420: sending discard information to a UPF according to the discard situation, where the discard information indicates a discard usage of the PDU set.

The PDU set information may come from the UPF, for example, when establishing a PDU session, the PDU set information is received from the UPF.

The PDU set information includes the PDU set size in bytes, which means that statistics on the discard usage of the PDU set can be simply performed. Therefore, based on the accurate statistics of UE or service traffic statistics, the statistics on the discard usage of the PDU set can be started.

As shown in FIG. 2E, an embodiment of the present disclosure provides an information processing method, which is performed by an RAN node and includes:
S1510: when correction indication is obtained, determining a discard situation of a PDU set; and
S1520: sending discard information to a UPF according to the discard situation, where the discard information indicates a discard usage of the PDU set.

For example, the correction indication may come from a core network node, an AF, or an AS. For example, the correction indication may come from an SMF, a PCF, or a UPF.

As another example, the correction indication may also be correction indication pre-configured by the RAN node.

In some embodiments, determining the discard situation of the PDU set may include:
performing statistics on the discard usage of the PDU set; or,
determining the discarded PDU set or the discarded PDUs in the PDU set.

In the case where the RAN node determines the discard usage of the PDU set, the RAN node will send the determined discard usage to the UPF.

The discard usage obtained through statistics by the RAN node may include a PDU set size in bytes of the discarded PDU set. For example, after determining the discarded PDU set, the RAN node may measure the data volume of each discarded PDU in the PDU set and perform statistics on the discard usage based on the measurements, ultimately obtaining the data volume of the entire discarded PDU set (i.e., the discard usage). Alternatively, in the case where the RAN node receives the PDU set information, the RAN node may determine the discarded PDU set and query the PDU set information of the discarded PDU set to obtain the PDU set size in bytes of the discarded PDU set.

There are multiple ways for the RAN node to send the discard usage to the UPF.

For example, the RAN node sends a discard report to the UPF, where the discard report carries the discard usage.

For another example, the RAN node returns one or more PDUs in the discarded PDU set to the UPF, and the one or more PDUs carry the discard usage. In this way, after receiving the discard report or the PDU carrying the discard usage, the UPF can know the volume of data in the PDU set discarded by the RAN node.

Furthermore, if the RAN node sends one or more PDUs in the discarded PDU set to the UPF, in order to be distinguished from PDUs in a uplink data flow, the one or more PDUs returned to the UPF can carry a discard mark, which facilitates the UPF to determine that the PDU currently received from the RAN node is the PDU originally used to carry the discard usage in the downlink data flow.

If the RAN node is unsure of the discard usage of the PDU set, the RAN node may return one or more PDUs in the discarded PDU set to the UPF, and the UPF performs statistics on the discard usage based on the one or more PDUs received from the RAN node. For example, in this case, to allow the UPF to distinguish, a discard marker may be included in the one or more PDUs returned to the UPF. It is worth noting that the operations of determining the discard usage of the PDU set, the discarded PDU set, and/or the discarded PDUs in the PDU set are all operations related to the discard usage of the PDU set, and such operations can also be referred to as statistical operations.

As shown in FIG. 2F, an embodiment of the present disclosure provides an information processing method, which is performed by an RAN node and includes:
S1610: when a PDU set QoS parameter includes PSIHI indicating that all PDUs in a PDU set need to be received by a receiver side, determining a discard situation of the PDU set according to a PDU set size in bytes in PDU set information; and
S1620: sending discard information to a UPF according to the discard situation, where the discard information indicates a discard usage of the PDU set.

For example, according to the PSIHI indicating that all PDUs in the PDU set need to be received by the receiver side, it can be determined that statistics on the discard usage of the PDU set are required, and the statistics on the discard usage of the PDU set can be specifically performed according to the PDU set size in bytes. For example, if the nth PDU set is discarded, statistics on the discard usage of the PDU set for the service data flow can be directly performed according to the size in bytes of the nth PDU set.

As shown in FIG. 2G, an embodiment of the present disclosure provides an information processing method, which is performed by an RAN node and includes:
S1710: when correction indication is obtained, performing statistics on a discard usage of a PDU set according to a PDU set size in bytes in PDU set information; and
S1720: sending discard information to a UPF, where the discard information indicates the discard usage of the PDU set.

The correction indication may be charging correction indication and/or usage statistics correction.

The traffic charging is based on the traffic usage by the UE. If the charging correction indication is received, it indicates that accurate charging is required, and the premise for the accurate charging is accurate traffic statistics. Therefore, when the charging correction indication is received, it is considered necessary to perform statistics on the discard usage of the PDU set, so as to realize accurate statistics on the traffic that is actually sent or received by the UE by discounting statistics on the discard usage, and realize accurate charging.

The usage statistics correction can indicate correction on the traffic used by the UE. In this case, it can be considered that the RAN node needs to perform statistics on the discard usage of the PDU set, so as to realize accurate statistics on the traffic that is actually sent or received by the UE by discounting the statistics on the discard usage.

In some embodiments, the correction indication may be correction indication sent by the SMF, UPF or policy control unit (PCF) that is received by the RAN node.

In some other embodiments, the RAN node may obtain the correction indication configured locally or configured by an Operation Administration and Maintenance (OAMF) node. For example, the RAN node may request the OAMF whether the correction indication is configured, and if the OAMF has configured the correction indication, the RAN node performs statistics on the discard usage of the PDU set.

For another example, the correction indication may include identification information and a correction symbol. The identification information may include: service identification, session identification, identification information of the PDU set, UE identification or account identification. The correction symbol indicates charging correction or usage statistics correction. In this way, the service, session, PDU set, receiving UE or receiving user for which the statistics on the discard usage of the PDU set are required can be determined according to the identification information, and the statistics on the discard usage of the PDU set can be started when the service data of the corresponding service is transmitted, the PDU is transmitted using the corresponding session, the PDU set is transmitted, or the PDU set is sent to the corresponding UE.

In some embodiments, determining the discard situation of the protocol data unit (PDU) set includes:
determining the discard usage of the PDU set according to the PDU set size in bytes in the PDU set information.

Since the PDU set size in bytes directly indicates the data volume of one or more PDU sets, the data volume of the discarded PDU sets can be accumulated based on the PDU set size in bytes, and the discard usage of the PDU sets can be easily obtained.

In another embodiment, the statistics on the discard usage of the PDU set can be performed by detecting traffic on each discarded PDU and performing statistics on the discard usage of the entire PDU set based on the detected traffic values.

As shown in FIG. 2H, an embodiment of the present disclosure provides an information processing method, which is performed by an RAN node and includes:
S1810: receiving a PDU set QoS parameter sent by a SMF through an Access Management Function (AMF), and/or receiving PDU set information sent by a UPF.

This embodiment can be combined with any of the above embodiments. The PDU set QoS parameter and/or the PDU set information of the UPF can be used for statistics on the discard usage of the PDU set by the RAN node.

The SMF and AMF are control plane nodes of the core network, that is, the RAN node can receive the PDU set QoS parameter through the control plane.

The UPF is a user plane node of the core network, that is, the RAN node can receive the PDU set information from the user plane.

It is worth noting that S1810 and S1820 can be performed separately or implemented in combination.

The PDU set QoS parameter and/or PDU set information received by the RAN node here may be used to determine the statistics of discard usage by the RAN node, or provide a basis for the statistics on discard usage of the PDU set.

In some embodiments, sending the discard information of the PDU set to the User Plane Function (UPF) according to the discard situation includes:
sending one or more PDUs in the discarded PDU set to the UPF, where the PDU carries a discard mark.

In some embodiments, the discard mark may be carried in a header of the PDU, or the discard mark may be appended to the end of the PDU. For another example, a reserved field in the PDU set is used to carry the discard mark. The discard mark may be indicated through one or more bits.

When the UPF receives the PDU carrying the discard mark sent by the RAN node, it can perform statistics on the discard usage of the PDU set according to the PDU.

For example, the data volume of each PDU in a PDU set is known in advance by the UPF. When one or more PDUs carrying a discard mark in the PDU set are received, it can be considered that the RAN node has discarded the entire PDU set, and the statistics on the discard usage of the PDU set can be performed based on the data volumes of the PDUs known in advance by the UPF.

For another example, the data volume of each PDU in a PDU set is the same. When one or more PDUs carrying a discard mark in a certain PDU set are received, it can be considered that the RAN node has discarded the entire PDU set, and data volume of the entire discarded PDU set is determined based on the data volume of the received PDUs carrying the discard mark and the number of PDUs in the PDU set, i.e., the obtained discard usage.

In some further embodiments, the PDU returned by the RAN node to the UPF may also directly carry the discard usage or the PDU set size in bytes of the discarded PDU set. For example, the PDU set information received by the RAN node carries the PDU size in bytes, and the PDU set size in bytes of the PDU(s) that can be directly discarded can be carried in one or more PDUs and sent to the UPF for the UPF to determine the discard usage.

In some embodiments, the RAN node may send a discard report including the discard usage to the UPF.

For example, reporting parameters of the discard report such as an information format and sending mode may be pre-negotiated between the RAN node and the UPF, or determined according to configuration of a gateway device. The discard report may be a message dedicated for transmission of the discard usage.

In some embodiments, sending the discard information to the UPF may include at least one of the following:
sending one or more PDUs in the discarded PDU set to the UPF, where the one or more PDUs carry the discard usage;
   sending one or more PDUs in the discarded PDU set to the UPF, where the one or more PDUs carry a discard mark; or
sending a discard report including the discard usage to the UPF.

For example, if the PDU returned to the UPF carries the discard mark but does not carry the discard usage, all discarded PDUs can be returned to the UPF so that the UPF can perform statistics on the discard usage by itself.

As another example, in scenarios where the PDU set information includes the PDU set size in bytes, the RAN node can send one or more PDUs in the discarded PDU set to the UPF, and after receiving the one or more PDUs in the discarded PDU set, the UPF can determine the discarded PDU set. In this case, the UPF may not need to measure the data volume of all PDUs in the discarded PDU set, but can directly determine the discard usage based on the PDU set size in bytes (PDU set size in byte) in the PDU set information. In this case, the PDU returned to the UPF may or may not carry the discard marker. In this scenario, the PDU returned to the UPF may further or may not carry the PDU set size in bytes. That is, when sending one or more PDUs to the UPF, the PDU may carry the discard marker, and the discard marker may be carried alone in the PDU or carried together with the discard usage to the UPF.

Regarding the discard usage and discard report (also referred to as a report for short), the RAN node can send the report to the UPF, and the report carries the discard usage counted by the RAN node.

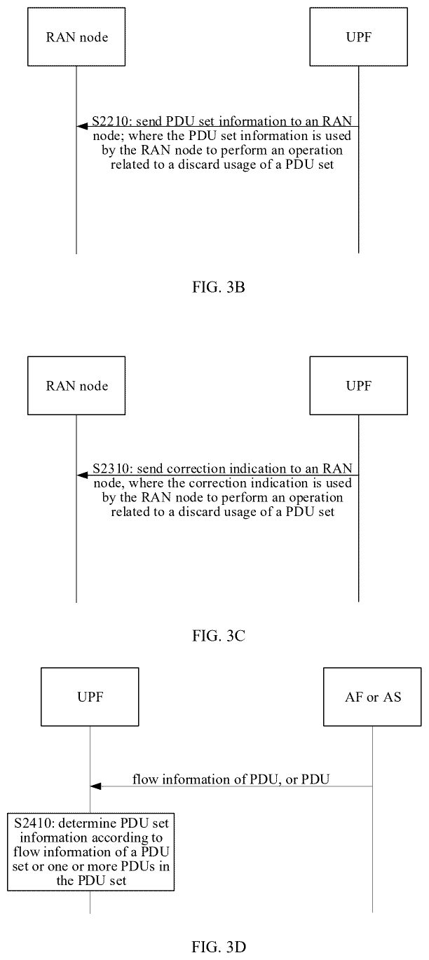

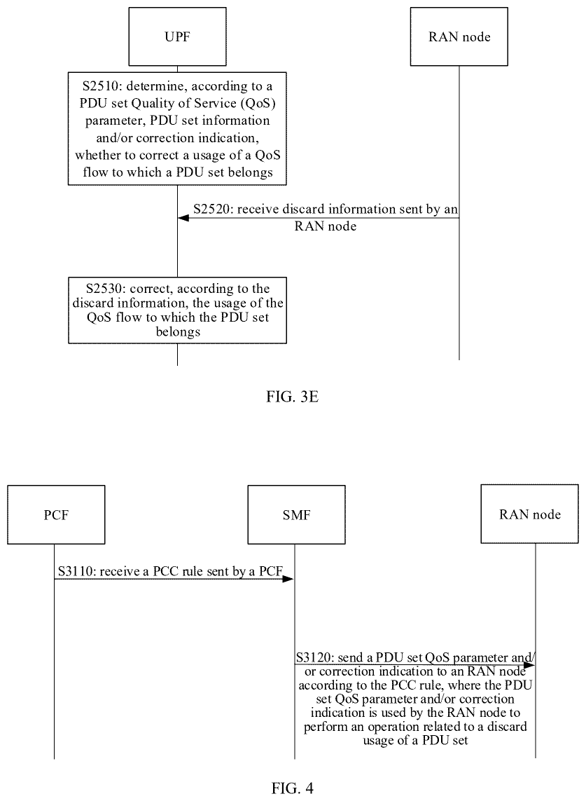

As shown in FIG. 3A, an embodiment of the present disclosure provides an information processing method, which is performed by a UPF and includes:
S2110: receiving discard information sent by an RAN node; where the discard information indicates a discard usage of a PDU set; and
S2120: correcting a usage of a QoS flow to which the PDU set belongs according to the discard information.

The UPF may be a serving UPF of the RAN node or a PDU Session Anchor (PSA) UPF.

The UPF may be the UPF as shown in FIG. 1. The UPF belongs to the core network nodes of the CN user plane.

If the UPF receives the discard information sent by the RAN node, it will correct the usage (or traffic) of the PDU set based on the discard information, or discount the discard usage determined based on the discard information from the charging usage statistics, thereby achieving charging correction or charging accuracy.

Since the RAN node can perform statistics on the discard usage of the PDU set in the downlink data flow, the UPF can achieve precise usage or charging of the PU set based on the enhanced functions of the RAN node.

In an embodiment, the discard information may include the discard usage. In this case, the UPF can discount the discard usage from its own statistical usage.

In another embodiment, the discard information may include one or more PDUs in the discarded PDU set, the PDU(s) may carry a discard mark and/or a discard usage. For example, the discard usage may include the PDU set size in bytes of the discarded PDU set.

In this case, after the UFP receives one or more PDUs in the discarded PDU set, if the received PDU set carries the discard usage, it can directly retrieve the discard usage. If the received PDU does not carry the discard usage, the UPF can determine the discarded PDU set based on the received PDU, and after determining the discarded PDU set, the UPF can determine the PDU set size in bytes of the discarded PDU set based on the PDU set information of the discarded PDU set. Alternatively, after receiving one or more PDUs belonging to the discard information, the data volume of the entire discarded PDU set (i.e., the discard usage) is determined based on the data volume of the individual PDUs.

In summary, in the embodiments of the present disclosure, the UPF can determine the discard usage of the PDU set according to the discard information received from the RAN node. After determining the discard usage, it performs correction on its own statistical usage. For example, the statistical usage may include charging usage obtained by performing statistics based on charging keywords and discounting the discard usage associated with the charging keywords from the charging usage counted by the UPF itself, thereby improving the accuracy of the charging usage.

As shown in FIG. 3B, an embodiment of the present disclosure provides an information processing method, which is performed by a UPF and includes:
S2210: sending PDU set information to an RAN node; where the PDU set information is used by the RAN node to perform an operation related to a discard usage of a PDU set.

For example, the UPF may receive the PDU set information from an AF, and thus, the UPF may send the received PDU set information to the RAN node.

After the PDU set information is sent to the RAN node, it can be used for the RAN node to determine whether to perform statistics on the discard usage for the PDU set, or used for calculation of discard usage statistics.

For example, the PDU set information may be carried in a protocol header of the PDU and sent to the RAN node. For example, the PDU set information may be carried in a General Packet Radio Service Tunneling Protocol (GPTU) header and sent to the RAN node.

As shown in FIG. 3C, an embodiment of the present disclosure provides an information processing method, which is performed by a UPF and further includes:
S2310: sending correction indication to an RAN node, where the correction indication is used by the RAN node to perform an operation related to a discard usage of a PDU set.

In some embodiments, the UPF may also trigger the RAN node to perform statistics on the discard usage by sending the correction indication to the RAN node. For example, the UPF may determine whether to perform statistics on the discard usage of the PDU set based on the PDU set information, or may perform statistics on the discard usage of the PDU set with reference to the PDU set information.

In some embodiments, the PDU set information includes at least one of the following:
a PDU set sequence number;
indication of an end PDU of the PDU set;
a PDU sequence number in the PDU set;
a PDU set size in bytes; or
importance information of the PDU set.

A data flow may include one or more PDU sets. These PDU sets may be numbered respectively, obtaining the PDU set sequence numbers that identify the PDU sets.

The end PDU set indication is indication of the end PDU set. For example, the end PDU set indication may include but is not limited to the sequence number of the last PDU set.

The PDU sequence number in the PDU set may include a sequence number of the first PDU and a sequence number offset. A sum of the sequence number of the first PDU set and the sequence number offset may be the sequence number of the last PDU set in the PDU set. For another example, if all PDUs in a PDU set are consecutively numbered, the sequence numbers of the PDUs in the PDU set may be indicated by the sequence number of the first PDU set and the sequence number of the end PDU. Of course, in some other embodiments, the sequence numbers of the PDUs in the PDU set are listed one by one.

The PDU set size in bytes is equivalent to clearly indicating a data volume of a PDU set, and the data volume is counted in bytes.

In some embodiments, the PDU set information includes the PDU set size in bytes. If the RAN performs PDU discarding per PDU set and can directly discard a certain PDU set, the discard usage can be directly determined based on the PDU set information without the RAN node performing statistics on the data volume for individual PDUs and determining the data volume of the entire PDU set based on the data volume of the individual PDUs, thereby simplifying the statistics on the discard usage of the PDU set by the RAN node, and thus having high compatibility with the RAN nodes in related art.

If the PDU set information includes the PDU set size in bytes, the statistics on the discard usage of the PDU set by the RAN node are simple to implement, and when receiving the PDU set information including the PDU set size in bytes, the RAN node can use it for the statistics on the discard usage of the PDU set.

The importance information of the PDU set may be used to indicate whether the entire PDU set will be discarded when one or more PDUs in the PDU set are discarded, or whether the discarding of PDUs in the PDU set will affect the discarding of other PDU sets.

If the PDU set information received by the RAN node indicates that at least one PDU set is of high importance and other PDU sets depend on this PDU set, and if this PDU set is lost, the RAN node will discard the other PDU sets, and in this case, the RAN node can perform the statistics on the discard usage of the PDU sets, so as to correct the usage or charging of the QoS flow. That is, if it is determined according to the importance information that one or more important PDU sets have been lost, or when one or more important PDU sets are lost, the RAN node may perform the statistics on the discard usage of the PDU sets.

Of course, those above are only examples of the PDU set information, and the specific implementation is not limited to the above examples.

As shown in FIG. 3D, an embodiment of the present disclosure provides an information processing method, which is performed by a UPF and further includes:
S2410: determining PDU set information according to flow information of a PDU set or one or more PDUs in the PDU set.

For example, the AF or AS will send the flow information of a protocol used in transmitting the PDU set to the UPF, or the UPF may obtain the flow information according to a PDU session when the PDU session is established or updated by the SMF. The flow information may include protocol description. The protocol description may include but is not limited to a protocol identifier or protocol content. The protocol identifier indicates a transmission protocol used for the service flow. The protocol content may include a protocol entry that can be used to determine whether the service flow contains a PDU set or whether all PDUs in the PDU set need to be received by the receiver side. Of course, these are just examples of the flow information, and the specific implementation is not limited to these examples.

For example, in an embodiment of the present disclosure, the transmission protocol used for PDU set transmission may include: a Real Time Protocol (RTP), a Secure Real-time Transport Protocol (SRTP), and a Real-time Transport Protocol (RTP). Of course, these are just examples of the protocols used for the PDU set transmission herein, and the specific implementation is not limited to these examples.

The flow information may be carried in one or more PDUs of the PDU set. Of course, the flow information may be provided to the UPF by the AF or AS during the PDU session establishment procedure.

In some embodiments, the PDU set information is carried in a protocol header, an extension header, or a payload of the PDU.

The protocol header may be encapsulated with information related to the protocol used for the PDU; the extension header may be a separate encapsulation from the protocol header. Both the protocol header and the extension header may be a type of packet header. In addition to the packet header, the PDU may also include the payload.

In the embodiments of the present disclosure, the PDU set information can be carried in any of the protocol header, extension header, or payload. In an embodiment, to reduce the overhead of PDU set information carried by the PDU, the PDU set size in bytes can be filled in the PDU to facilitate the RAN node to perform statistics on the discard usage of the PDU set. In this case, the UPF decodes the PDU set size in bytes from the PDU and directly provides it to the corresponding RAN node.

In some embodiments, the method further includes: receiving correction indication from a Policy Control Function (PCF).

The UPF can generate the correction indication on its own, for example, based on local configuration or OAM configuration. The UPF can also obtain the correction indication sent from the PCF or SMF. The UPF can receive the correction indication directly from the PCF or SMF, or directly from the AF. After receiving the correction indication, the UPF can provide the correction indication to the RAN node, triggering the RAN node to perform statistics on the discard usage of the PDU set.

If the UPF receives the correction indication from the PCF or SMF, the UPF stores the correction indication locally.

In some embodiments, the method further includes:
receiving a PDU set Quality of Service (QoS) parameter.

The UPF may also receive the PDU set QoS parameter from the SMF. The PDU set QoS parameter may be used for the UPF to determine whether it is necessary to perform statistics on the discard usage of the PDU set. If so, discard information may be received from the RAN node. In some other embodiments, the UPF may also determine whether it is necessary to perform statistics on the discard usage of the PDU set based on the PDU set information and/or correction indication received from the SMF. In other words, the UPF may determine whether it is necessary to correct a usage of a QoS flow to which the PDU set belongs based on any one of the PDU set QoS parameter, the PDU set information and/or the correction indication, or a combination of any two thereof.

If the UPF receives the PDU set QoS parameter from the SMF, the UPF stores the PDU set QOS parameters locally.

In an embodiment of the present disclosure, if the UPF receives the PDU set QoS parameter from the SMF, it may also send the PDU set QoS parameter to the RAN node.

As shown in FIG. 3E, an embodiment of the present disclosure provides an information processing method, which is performed by a UPF and further includes:
S2510: determining, according to a PDU set Quality of Service (QoS) parameter, PDU set information and/or correction indication, whether to correct a usage of a QoS flow to which a PDU set belongs;
S2520: receiving discard information sent by an RAN node; and S2530: correcting, according to the discard information, the usage of the QoS flow to which the PDU set belongs.

If the UPF does not need to perform usage correction, it does not need to receive the discard information from the RAN node, or does not need to send information relevant to performing statistics on the discard usage of the PDU set to the RAN node, thereby reducing unnecessary operations of the RAN node and the UPF.

As shown in FIG. 4, an embodiment of the present disclosure provides an information processing method, which is performed by a Session Management Function (SMF), and the method includes:
S3110: receiving a PCC rule sent by a PCF; and
S3120: sending a PDU set QoS parameter and/or correction indication to an RAN node according to the PCC rule, where the PDU set QoS parameter and/or correction indication is used by the RAN node to perform an operation related to a discard usage of a PDU set.

The information processing method can be performed by the SMF, and the SMF can receive the PCC rule from the PCF and generate the PDU set QoS parameter according to the PCC rule.

For example, the PCC rule includes the PDU set QoS parameter. The SMF parses the PCC rule to extract the PDU set QoS parameter, and the PDU set QoS parameter can be sent from the control plane to the RAN node through the AMF.

As another example, the SMF can directly determine, based on the PCC rule or the PDU set QoS parameter extracted from the PCC rule, whether the RAN node needs to perform statistics on the discard usage of the PDU set. If so, the SMF can directly send the correction indication to the RAN node through the UPF or AMF. Otherwise, it needs not to send the correction indication to the RAN node.

In some embodiments, the SMF may send the PDU set QoS parameter or the correction indication separately, or may send the PDU set QoS parameter and the correction indication to the RAN node at the same time.

The correction indication and the PDU set QoS parameter can be used together by the RAN node to determine whether statistics on the discard usage of the PDU set are required. For example, upon receiving the correction indication, the RAN node can further determine, based on the PDU set QoS parameter, whether statistics on the discard usage of the PDU set are required, and if no correction indication is received, the RAN node can directly determine that statistics on the discard usage of the PDU set are not required. Of course, this is merely an example, and the specific implementation is not limited to this example.

In some embodiments, the PDU set QoS parameter includes at least one of the following:
PDU Set Integrated Handling Information (PSIHI), indicating whether all PDUs in the PDU set need to be received by the receiver side;
PDU Set Error Rate (PSER), indicating an upper limit of a proportion of reception failures of the PDU set; or
PDU Set Delay Budget (PSDB), indicating a difference in time of arriving at a receiver end between the first PDU and the end PDU in the PDU set.

If the PDU set QoS parameter includes the PSIHI, it can be determined based on the PSIHI whether the RAN node performs statistics on the discard usage of the PDU set. For example, if the PSIHI indicates that all PDUs in the PDU set need to be successfully received by the receiver side, in this case, if one PDU in the PDU set is lost, the RAN node will discard the entire PDU set. In this case, for a single UE or a single service, a large number of PDU discards will occur, resulting in a relatively large discard usage. Therefore, in this case, if the PDU set QoS parameter includes the PSIHI and the PSIHI indicates that all PDU sets or all PDUs in a PDU set are received by the receiver side, it is even more important to perform determination on the discard situation of the PDU set.

In some embodiments, the PDU set QoS parameter may include the PSER. This PSER may indicate an upper limit on the proportion of reception failures. As such, if the RAN node finds that the current number of discarded PDUs has reached the upper limit, it may be possible that all the remaining PDUs or PDU sets will be discarded, and in this case, there will be a large number of PDUs being discarded. To reduce the inaccuracy of downlink traffic statistics for a single UE, a single user, or a single service, it needs to initiate the determination on the discard situation of the PDU set by the RAN node. This upper limit can be the upper limit on the proportion of reception failures for a single PDU set, or the upper limit on the proportion of reception failures for all PDU sets in a service transmission.

In some embodiments, if the delay for all PDUs in a PDU set to arrive at the receiver side is greater than the maximum delay indicated by the PDU set QoS parameter, that is, the actual delay is greater than the PSDB indicated by the PDU set QoS parameter, the entire PDU set can be discarded. In this case, a large number of PDUs will be discarded. In order to reduce the inaccuracy of downlink traffic statistics for a single UE, a single user or a single service, it needs to initiate determination on the discard situation of the PDU set by the RAN node.

Of course, the PDU set QoS parameter may include one or more of the above parameters. In some embodiments, the PDU set QoS parameter may also include a minimum guaranteed bandwidth, etc.

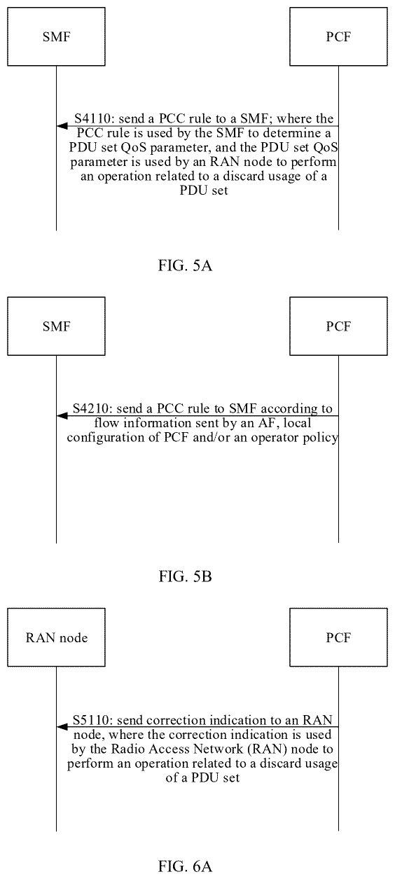

As shown in FIG. 5A, an embodiment of the present disclosure provides an information processing method, which is performed by a PCF and includes:
S4110: sending a PCC rule to a SMF; where the PCC rule is used by the SMF to determine a PDU set QoS parameter, and the PDU set QoS parameter is used by an RAN node to perform an operation related to a discard usage of a PDU set.

In the embodiment of the present disclosure, the PCF sends the PCC rule to the SMF. The PCC rule may directly or indirectly include the PDU set QoS parameter, and may be used for the SMF to determine the PDU set QoS parameter that is used for the RAN node to determine whether to perform statistics on the discard usage of the PDU set.

Of course, the PDU set QoS parameter is also used for the SMF to perform QoS processing.

In an embodiment, the PDU set QoS parameter includes at least one of the following:
PDU Set Integrated Handling Information (PSIHI), indicating whether all PDUs in the PDU set need to be received by the receiver side;
PDU Set Error Rate (PSER), indicating an upper limit of a proportion of reception failures of the PDU set; or
PDU Set Delay Budget (PSDB), indicating a difference in time of arriving at a receiver end between the first PDU and the end PDU in the PDU set.

Of course, those above are specific examples of the PDU set QoS parameter, and the specific implementation is not limited to the above examples.

As shown in FIG. 5B, an embodiment of the present disclosure provides an information processing method, which is performed by a PCF and includes:
S4210: sending a PCC rule to a SMF according to flow information sent by an AF, local configuration of the PCF and/or an operator policy.

The flow information may be provided by the AF to the PCF. For example, the flow information is flow description of a Service Data Flow (SDF).

The PCF may have the local configuration to determine whether to generate a PDU set QOS parameter for the RAN node to perform statistics on the discard usage of the PDU set. The operator policy may be information pre-configured by the communication operator.

In summary, in the embodiments of the present disclosure, the PCC rule may be generated based on the flow information, the local configuration and/or the operator policy and sent to the SMF.

In some embodiments, the flow information includes at least one of the following:
PDU set related assistance information; or
QoS Configuration.

The flow information (i.e., the aforementioned flow description) may include the assistance information related to the PDU set, which is received from the AF in the PDU session establishment or update procedure. For example, if the AF is located outside the CN, the AF can connect to the SMF, UPF, RAN node, etc. of the CN through a Network Exposure Function (NEF) included in the CN. If the AF is located within the CN, the AF can directly provide the PDU set related information to the PCF.

For example, the flow information or flow description may include protocol description.

The PDU set assistance information can be used for dynamic formulation of the PCC rule. That is, the PDU set assistance information carrying any information related to the PCC rule can be sent to the PCF in a PDU session establishment phase, during a PDU session ongoing procedure, or during a PDU session update procedure. The PCF can update the PCC rule after receiving the PDU set related information.

The QoS configuration, also known as a QoS profile, can also be used by PCF to generate the PCC rule.

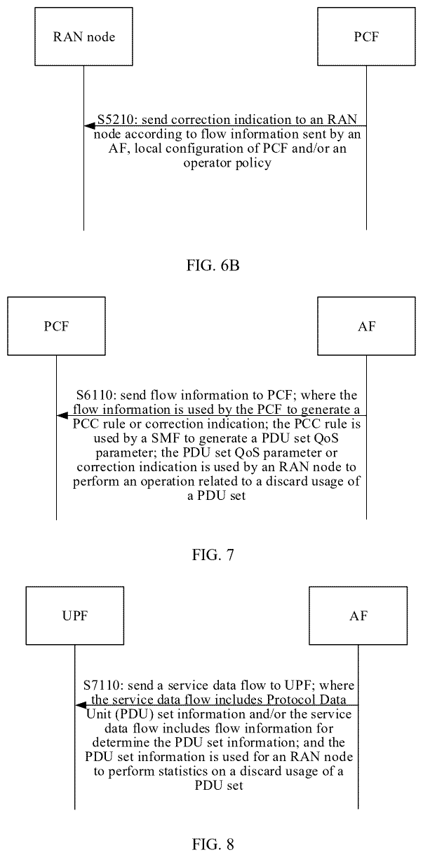

As shown in FIG. 6A, an embodiment of the present disclosure provides an information processing method, which is performed by a PCF and includes:
S5110: sending correction indication to an RAN node, where the correction indication is used by the Radio Access Network (RAN) node to perform an operation related to a discard usage of a PDU set.

The PCF can generate the correction indication, which can be sent to the RAN node through nodes such as the AMF. The RAN node can perform statistics on the discard usage of the PDU set according to the correction indication.

As shown in FIG. 6B, an embodiment of the present disclosure provides an information processing method, which is performed by a PCF and includes:
S5210: sending correction indication to an RAN node according to flow information sent by an AF, local configuration of a PCF and/or an operator policy.

The flow information may be provided by the AF to the PCF. For example, the flow information is flow description of a Service Data Flow (SDF).

The PCF may have the local configuration to determine whether to generate a PDU set QoS parameter for the RAN node to perform statistics on the discard usage of the PDU set. The operator policy may be information pre-configured by the communication operator.

If the correction indication is generated according to the flow information and the flow information is received from the AF, the flow information needs to be received from the AF before the correction indication is generated.

In summary, in the embodiments of the present disclosure, the correction indication may be generated based on the flow information, the local configuration and/or the operator policy and sent to the SMF. The PCF may send the correction indication to the RAN node directly or indirectly.

In some embodiments, the flow information includes at least one of the following:
PDU set related assistance information; or
QoS configuration.

The flow information (i.e., the aforementioned flow description) may include the assistance information related to the PDU set, which is received from the AF in the PDU session establishment or update procedure. For example, if the AF is located outside the CN, the AF can connect to the SMF, UPF, RAN node, etc. of the CN through a Network Exposure Function (NEF) included in the CN. If the AF is located within the CN, the AF can directly provide the PDU set related information to the PCF.

The PDU set assistance information can be used for dynamic formulation of the PCC rule. That is, the PDU set assistance information carrying any information related to the PCC rule can be sent to the PCF in a PDU session establishment phase, during a PDU session ongoing procedure, or during a PDU session update procedure. When receiving the PDU set related information, the PCF can determine whether the RAN node needs to perform statistics on the discard usage of the PDU set. If so, the correction indication can be generated; otherwise, no correction indication is generated.

The QoS configuration, which may also be referred to as a QoS profile, may also be used by the PCF to generate the PCC rule. In an embodiment of the present disclosure, the PCF may generate the correction indication according to the QoS configuration.

As shown in FIG. 7, an embodiment of the present disclosure provides an information processing method, which is performed by an AF and includes:
S6110: sending flow information to a PCF; where the flow information is used by a PCF to generate a PCC rule or correction indication; the PCC rule is used by a SMF to generate a PDU set QoS parameter; the PDU set QoS parameter or correction indication is used by an RAN node to perform an operation related to a discard usage of a PDU set.

The flow information may be provided by the AF to the PCF. For example, the flow information is flow description of a Service Data Flow (SDF).

The PCC rule may be used for QoS processing of services relevant to the AF.

The correction indication may be indication dedicated to indicate whether the RAN node performs statistics on the discard usage of the PDU set. The correction indication may be charging correction indication or usage correction indication.

As such, the transmission network can perform accurate statistics or accurate charging on the usage of the service data flow, UE or user account (i.e., traffic usage or data usage).

In some embodiments, the flow information includes at least one of the following:
PDU set related assistance information; or
QoS configuration.

The flow information (i.e., the aforementioned flow description) may include the assistance information related to the PDU set, which is received from the AF in the PDU session establishment or update procedure. For example, if the AF is located outside the CN, the AF can connect to the SMF, UPF, RAN node, etc. of the CN through a Network Exposure Function (NEF) included in the CN. If the AF is located within the CN, the AF can directly provide the PDU set related information to the PCF.

The PDU set assistance information can be used for dynamic formulation of the PCC rule. That is, the PDU set assistance information carrying any information related to the PCC rule can be sent to the PCF in a PDU session establishment phase, during a PDU session ongoing procedure, or during a PDU session update procedure. When receiving the PDU set related information, the PCF can determine whether the RAN node needs to perform statistics on the discard usage of the PDU set. If so, the correction indication can be generated; otherwise, no correction indication is generated.

The QoS configuration, which may also be referred to as a QoS profile, may also be used by the PCF to generate the PCC rule. In the embodiment of the present disclosure, the PCF may generate the correction indication based on the QoS configuration.

As shown in FIG. 8, an embodiment of the present disclosure provides an information processing method, which is performed by an AF or an AS and includes:
S7110: sending a service data flow to a UPF; where the service data flow includes Protocol Data Unit (PDU) set information and/or the service data flow includes flow information for determining the PDU set information; and the PDU set information is used for an RAN node to perform statistics on a discard usage of a PDU set.

For example, the flow information is carried in a protocol header, an extension header, or a payload of the PDU.

The AF or AS sends the service data flow to UE through the UPF. In an embodiment of the present disclosure, the flow information or PDU set information is directly carried in the PDU of the service data flow and sent to UPF, so there is no need for an additional process to send the PUD set information and/or flow information to the UPF.

In some embodiments, the PDU set information and/or flow information is carried in a protocol header, an extension header, or a payload of one or more PDUs of the QoS flow.

In some embodiments, the PDU set information includes at least one of the following:
a PDU set sequence number;
indication of an end PDU of the PDU set;
a PDU sequence number in the PDU set;
a PDU set size in bytes; or
importance information of the PDU set.

A data flow may include one or more PDU sets. These PDU sets may be numbered respectively, obtaining the PDU set sequence numbers that identify the PDU sets.

The end PDU set indication is indication of the last PDU set. For example, the end PDU set indication may include but is not limited to the sequence number of the last PDU set.

The PDU sequence number in the PDU set may include a sequence number of the first PDU and a sequence number offset. A sum of the sequence number of the first PDU set and the sequence number offset may be the sequence number of the last PDU set in the PDU set. For another example, if all PDUs in a PDU set are consecutively numbered, the sequence numbers of the PDUs in the PDU set may be indicated by the sequence number of the first PDU set and the sequence number of the end PDU. Of course, in some other embodiments, the sequence numbers of the PDUs in the PDU set are listed one by one.

The PDU set size in bytes is equivalent to clearly indicating a data volume of a PDU set, and the data volume is counted in bytes.

In some embodiments, the flow information may be flow information of a protocol used for PDU set transmission. The flow information may include protocol description. The protocol description may include a protocol identifier or protocol content.

For example, in an embodiment of the present disclosure, the transmission protocol used for the PDU set transmission may include: a Real Time Protocol (RTP), a Secure Real-time Transport Protocol (SRTP), and a Real-time Transport Protocol (RTP). Of course, these are just examples of the protocols used for the PDU set transmission herein, and the specific implementation is not limited to these examples.

The flow information may be carried in one or more PDUs of the PDU set. Of course, the flow information may be provided to the UPF by the AF or AS during the PDU session establishment procedure.

In some embodiments, the PDU set information is carried in a protocol header, an extension header, or a payload of the PDU.

The protocol header may be encapsulated with information related to the protocol used for the PDU; the extension header may be a separate encapsulation from the protocol header. Both the protocol header and the extension header may be a type of packet header. In addition to the packet header, the PDU may also include the payload.

In the embodiments of the present disclosure, the PDU set information can be carried in any of the protocol header, extension header, or payload. In an embodiment, to reduce the overhead of PDU set information carried by the PDU, the PDU set size in bytes can be filled in the PDU to facilitate the RAN node to perform statistics on the discard usage of the PDU set. In this case, the UPF decodes the PDU set size in bytes from the PDU and directly provides it to the corresponding RAN node.

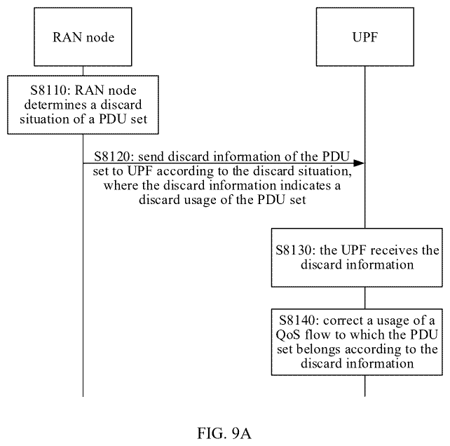

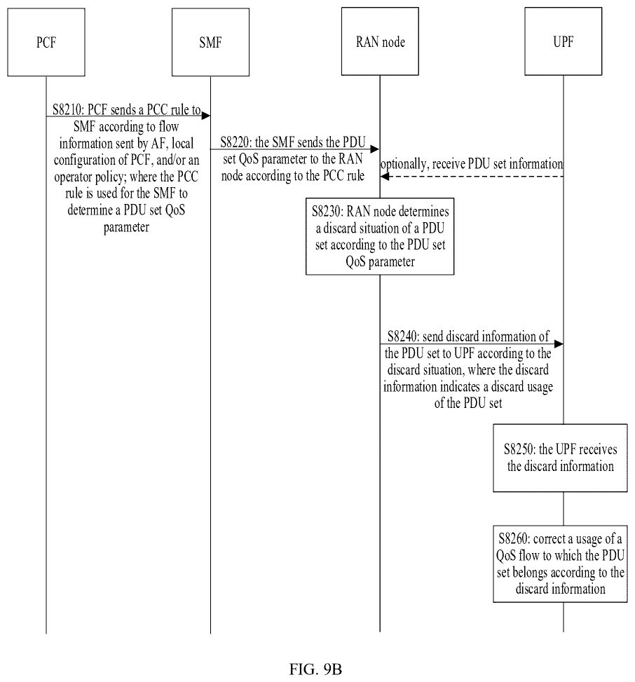

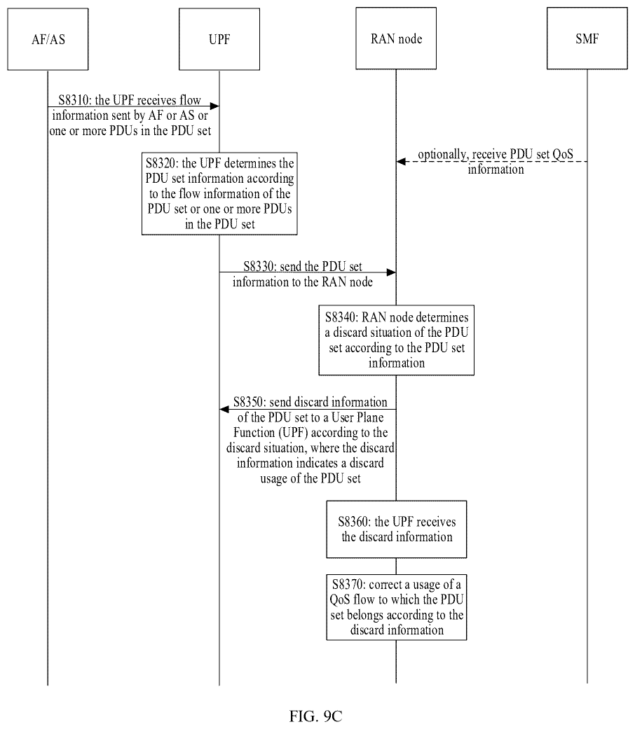

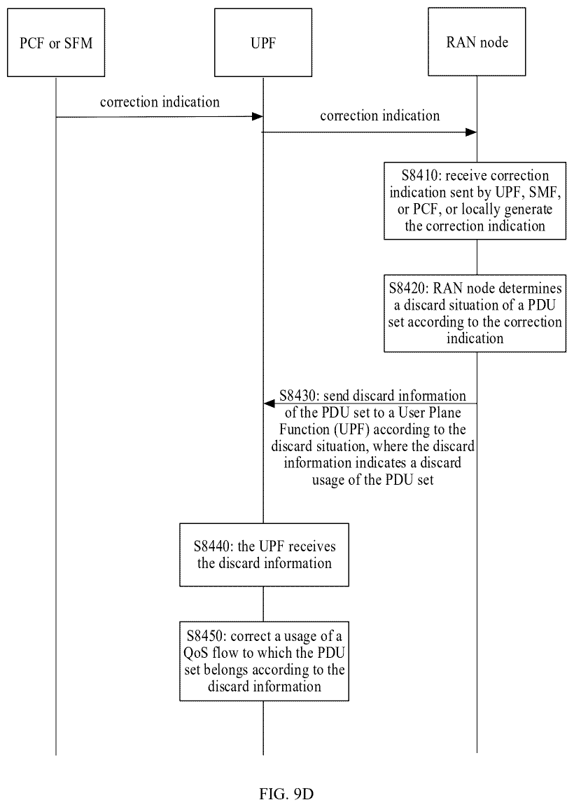

As shown in FIG. 9A, an embodiment of the present disclosure provides an information processing method, which can be performed by a wireless communication system. The method may include:
S8110: an RAN node determines a discard situation of a PDU set;
S8120: discard information of the PDU set is sent to a UPF according to the discard situation, where the discard information indicates a discard usage of the PDU set;
S8130: the UPF receives the discard information; and
S8140: a usage of a QoS flow to which the PDU set belongs is corrected according to the discard information.

The discard information may include: a PDU carrying a discard mark, a PDU set size in bytes and/or a discard usage. Alternatively, the discard information may include: a discard report including the discard usage.

In some embodiments, the Radio Access Network (RAN) node determines the discard situation of the Protocol Data Unit (PDU) set, including at least one of the following: when the PDU set QoS parameter includes the PSIHI indicating that all PDUs in the PDU set need to be received by a receiver side, determining the discard situation of the PDU set; when the PDU set information includes the PDU set size in bytes, determining the discard situation of the PDU set; or when the correction indication is obtained, determining the discard situation of the PDU set.

The correction indication may come from a PFC, SMF, UPF, AF, or AS, or be generated locally by the RAN node.

For example, the AF may be a network function of a control plane related to a service; and the AS may be a network function of a user plane.

As shown in FIG. 9B, an embodiment of the present disclosure provides an information processing method, which can be performed by a wireless communication system. The method may include:
S8210: a PCF sends a PCC rule to a SMF based on flow information sent by an AF, local configuration of the PCF, and/or an operator policy; where the PCC rule is used for the SMF to determine a PDU set QoS parameter;
S8220: the SMF sends the PDU set QoS parameter to the RAN node according to the PCC rule;
S8230: the RAN node determines a discard situation of a PDU set according to the PDU set QoS parameter;
S8240: discard information of the PDU set is sent to a UPF according to the discard situation, where the discard information indicates a discard usage of the PDU set;
S8250: the UPF receives the discard information; and
S8260: a usage of a QoS flow to which the PDU set belongs is corrected according to the discard information.

That is, the PCF sends the PCC rule to the SMF when receiving the flow information sent by the AF, or based on the local configuration or operator. After receiving the PCC rule, the SMF parses the PCC rule and generates the PDU set QoS parameter. The SMF sends the PDU set QoS parameter to the RAN node through the control plane. For example, the SMF sends the PDU set QoS parameter to the RAN node through the AMF.

For example, S8240 may include: when the PDU set QoS parameter includes PSIHI indicating that all PDUs in the PDU set need to be received by the receiver side, determining a discard situation of the PDU set.

It is worth noting that the PDU set QoS parameter may include not only the PSIHI, but also PSER and/or PSDB, etc.

As shown in FIG. 9C, an embodiment of the present disclosure provides an information processing method that can be performed by a wireless communication system. The method may include:
S8310: the UPF receives flow information sent by the AF or AS or one or more PDUs in the PDU set;
S8320: the UPF determines the PDU set information according to the flow information of the PDU set or one or more PDUs in the PDU set;
S8330: the PDU set information is sent to the RAN node;
S8340: the RAN node determines a discard situation of the PDU set according to the PDU set information;
S8350: discard information of the PDU set is sent to a User Plane Function (UPF) according to the discard situation, where the discard information indicates a discard usage of the PDU set;
S8360: the UPF receives the discard information; and
S8370: a usage of a QoS flow to which the PDU set belongs is corrected according to the discard information.

In the embodiment of the present disclosure, the UPF determines PDU set information and, after determining the PDU set information, directly sends the PDU set information to the RAN node through the user plane. Upon receiving the PDU set information, the RAN node determines whether to start the determination of the discard situation for the PDU set. If so, it determines the discard situation and sends the discard information to the UPF.

For example, when the PDU set information includes the PDU set size in bytes, the discard situation of the PDU set is determined, and the discard information is sent to the UPF.

That is, the PDU set information is sent to the RAN node through the user plane, and the RAN node determines whether to perform operations related to the discard usage of the PDU set.

For example, the PDU set information may include but is not limited to the PDU set size in bytes, the PDU set sequence number and/or the PDU sequence number in the PDU set, etc.

As shown in FIG. 9D, an embodiment of the present disclosure provides an information processing method that can be performed by a wireless communication system. The method may include:
S8410: correction indication sent by a UPF, SMF, or PCF is received, or the correction indication is locally generated;
S8420: an RAN node determines a discard situation of a PDU set according to the correction indication;
S8430: discard information of the PDU set is sent to a User Plane Function (UPF) according to the discard situation, where the discard information indicates a discard usage of the PDU set;
S8440: the UPF receives the discard information; and
S8450: a usage of a QoS flow to which the PDU set belongs is corrected according to the discard information.

In the embodiment of the present disclosure, the RAN node determines the discard situation based on the correction indication, which may be determined based on the related information such as the QoS parameter of the PDU set and/or PDU set information described above.

In the information processing method shown in FIGS. 9A to 9D, regarding how the RAN node specifically determines the discard request and how to send the discard information to the UPF, reference be made to the corresponding embodiments described above, which will not be repeated here.

The RAN node cannot perform QoS flow usage statistics. The UPF also cannot obtain usage statistics of active discard associated with QoS flow charging in this scenario. In view of this, embodiments of the present disclosure provide an information processing method to implement enhancement of charging functionality in PDU-based QoS processing scenarios, enabling accurate metering and charging of downlink data flows.

The RAN node cannot perform usage statistics and discard usage statistics associated with QoS flow charging. The UPF also cannot obtain usage statistics of active discard associated with QoS flow charging in this scenario. How to effectively enhance the charging functionality in PDU set-based QoS processing scenarios to achieve accurate charging for downlink data flows becomes the technical problem to be solved by the embodiments of the present disclosure.

The embodiments of the present disclosure provide an information processing method involving the access network node and core network node and AF and/or AS, etc. For example, a PDU set QoS parameter and PDU set information are sent to the RAN node, and the RAN node performs discard data statistics related to the PDU set based on the received PDU set QoS parameter and PDU set information, and reports the statistical discard usage to UPF for UPF to perform charging correction.

When the PDU set QoS parameter includes PDU Set Integrated Handling Information (PSIHI) which indicates that all PDUs in the PDU set are required, the RAN node will discard PDUs per PDU set. If the RAN node discards the entire PDU set, the RAN performs discard usage statistics of the PDU set size.

When the PDU set information includes the PDU set size in bytes, if the entire PDU set is discarded, the RAN directly performs statistics on the PDU set size data in the PDU set information as the discard usage.

The PDU set QoS parameter is sent from the control plane to the RAN; for example, the PDU set QoS parameter is sent from the SMF to the RAN (through the AMF).

The PDU set information is sent from the user plane to the RAN; for example, the PDU set information is sent from the UPF to the RAN.

For the PDU set QoS parameter, the PCF determines the PDU set QoS parameter based on information provided by the AF and/or local configuration, includes the PDU set QoS parameter in PCC rule and sends it to the SMF. The SMF sends it to the NG-RAN as part of the QoS Profile for PDU set QoS processing. For example, the PDU set QoS parameter (for example, the PSIHI) can be provided by the AF to the PCF during the AF session with required QoS process.

The PDU set information is used by the UPF to identify the PDU set information of the downlink flow.

The UPF identifies and generates the PDU set information based on the protocol description, RTP/SRTP protocol header, or other specific implementations. For example, the PDU set information (especially PDU set size in bytes) is carried in the protocol header, extension header, or payload and sent to the UPF. The PDU set information is carried in a GPTU protocol header and sent to the RAN.

The PDU set QoS parameter includes one or more of the following:

PSIHI, indicating whether all PDUs of the PDU set are needed for use by the application layer in the receiver side. PSER, defining an upper bound for the rate of PDU sets that have been processed by the sender of a link layer protocol but that are not successfully delivered by the corresponding receiver to the upper layer.

PSDB, defining an upper bound for the delay that a PDU set may experience for the transfer between the UE and a N6 termination point at the UPF, i.e. a time difference between the reception time of the first PDU and the time when all PDUs of a PDU set have been successfully received.

The PDU set information includes at least one of the following:
PDU Set Sequence Number;
Indication of End PDU of the PDU set;
PDU Sequence Number within a PDU set;
PDU Set Size in bytes; or
PDU Set Importance information, which identifies the importance of the PDU set compared to other PDU sets within a QoS flow to which the PDU set belongs.

Optionally, the RAN performs statistics and reporting of the discard usage related to the PDU set according to the charging correction indication.

The charging correction indication indicates whether to perform statistics and reporting on the discard usage of the PDU set.

The charging correction indication may be sent by the SMF or UPF, or configured by OAM, or locally configured by the RAN.

In some embodiments, the RAN performing charging correction on the discard usage of the PDU set further includes: the RAN sending one or more PDUs in the discarded PDU set to the UPF, carrying the PDU set size in bytes and a discard mark.

The UPF performs discard usage of the discarded PDU set.

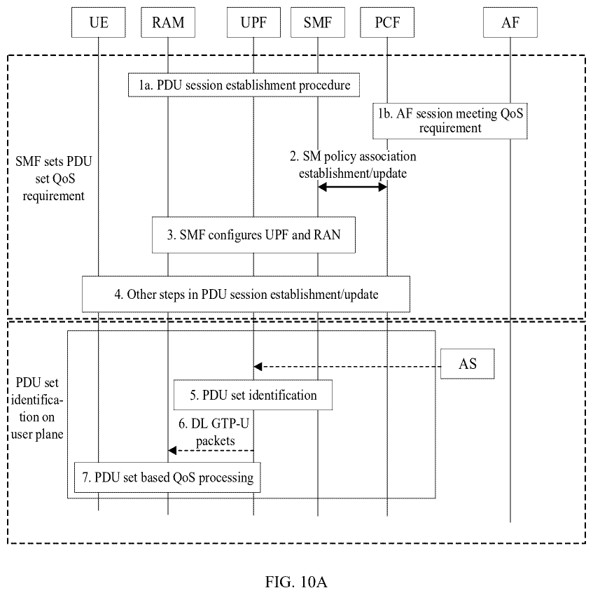

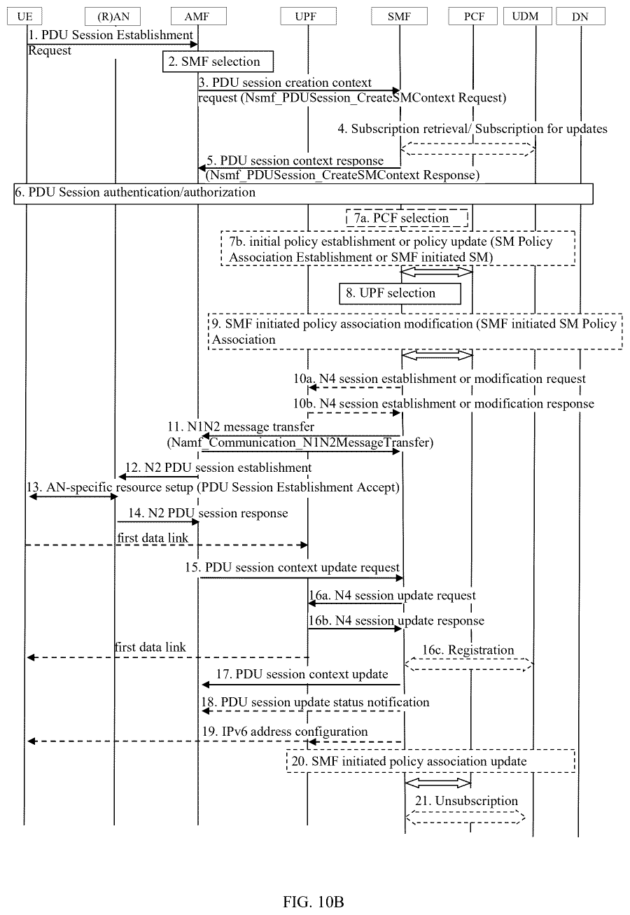

The information processing method provided in the embodiments of the present disclosure can be used to perform statistics on the discard usage of the PDU set, usage correction, and/or charge correction, which may occur during a PDU session establishment or modification procedure. Referring to FIG. 10A, the entire process includes the following steps:
1a. Steps 1-7a of PDU session establishment procedure are performed, which are the same as steps 1 to 7a of the relevant PDU session creation process.
1b. The AF can send information to the PCF through the Nnef_AFsessionWithQoS_Create request. For example, the AF can send this request information to provide the PCF with the QoS parameters of each PDU set in the QoS flow and/or frame identification parameters, etc. The AF can also provide this information to the 5^{th} Generation System (5GS) prior to the PDU session establishment.

The AF can provide PDU set related assistance information for dynamic PCC control. For example, the AF can provide to the NEF/PCF one or more of the following PDU set related assistance information using an AF session with the required quality of service. The PDU set related assistance information includes: PDU set QoS parameters and/or protocol description. For example, the protocol description can be used to determine the protocol and/or payload type used by the service data flow.

The PDU set QoS parameters and protocol description provided by the AF can be used in determining the QoS configuration by the PCF and identifying the PDU set information by the PSA UPF.

The PDU set QoS parameter includes one or more of the following:

PSIHI, which can be used to indicate whether all PDUs in the PDU set needs to be used by the application layer in the receiving side.

PSER, which defines an upper bound for the rate of PDU sets that have been processed by the sender of a link layer protocol (e.g. RLC in RAN of a 3GPP access) but are not successfully delivered by the corresponding receiver to the upper layer (e.g. PDCP in RAN of a 3GPP access).

PSDB, which defines an upper bound of transmission delay of a PDU set. For example, for a PDU set, the delay between the first PDU reaching the receiver and the last PDU reaching the receiver in the transmission between the UE and UPF.

The PCF generates PCC rules. The PCC rule may include PDU set QoS parameters. The PCF sends the PCC rules to the SMF.

The SMF generates the QoS configuration and N4 rule based on the PCC rules. The SMF sends the N4 rule to the UPF and sends the QoS configuration to the RAN node. For example, the SMF sends the QoS configuration to the RAN node through the AMF.

In some embodiments, the QoS configuration or N4 rule may also include correction indication. This correction indication may be charging correction indication or usage correction indication. In some other embodiments, the QoS configuration is also synchronized to the UPF, as such, the UPF is aware of the PDU set QoS parameters and/or correction indication carried in the QoS configuration, thereby aligning with the RAN node's decision on whether to perform statistics on the discard usage of the PDU set. Of course, when the QoS configuration is synchronized to the UPF, the UPF can perform QoS control based on the QoS configuration.

FIG. 10B shows the PDU session establishment process. The statistics based on the discard usage of the PDU set may occur in steps 2-7 or steps 8-15 of the PDU session establishment process. Of course, in some embodiments, the statistics based on the discard usage of the PDU set may occur during the PDU session update process.

For example, as shown in FIG. 10B, the statistics based on PDU set discard usage may occur in steps 2-7, and selection of the PCF is performed in step 7a. After the PCF selection is completed, the PDU set QoS parameters, PDU set information and/or correction indications may be provided to the UPF and/or RAN node through the SM policy association and SMF initial SM policy association modification steps.

Based on rule or local configuration, the UPF identifies the following PDU set information and perform QoS processing according to N4 rule.

The set information of the downlink flow identified by the UPF may include at least one of the following:
a PDU Set Sequence Number;
indication of end PDU in the PDU set;
PDU Sequence Number within a PDU set; or
PDU set size in bytes.

PDU set Importance, which identifies the importance of the PDU set relative to other PDUs in the QoS flow.

The UPF identifies and generates PDU set information based on the flow information, RTP/SRTP protocol header or specific implementation.

Furthermore, the PDU set information, especially the PDU set size in bytes, is carried to the UPF in a protocol header, extension header or payload.

The UPF sends the PDU set information to the RAN node. For example, the PDU set information is carried in a GPTU protocol header and provided to the RAN.

Based on the PDU set related information obtained in a PDU session authentication and authorization process and/or the PDU set QoS parameters provided in step 3, the RAN node performs QoS processing of the PDU set.

Based on the received PDU set QoS parameters and/or PDU set information, the RAN performs PDU set related discard data statistics and reports the statistical discard usage to UPF for UPF to perform charging correction.

The PCF generates and provides PCC rules, including the PDU set QoS parameters, to the SMF.

When the PDU set QoS parameter includes the PSIH) of the PDU set, it indicates that all PDUs in the PDU set are required, and if the RAN discards the entire PDU set, the RAN performs usage statistics on the set size.

The PDU set QoS parameters are sent from the control plane to the RAN; further, the PDU set QoS parameters are sent from the SMF to the RAN.

Optionally, the PCF sends charging correction indication to the RAN.

The RAN performs PDU set related discard usage statistics and reporting according to the charging correction indication; the charging correction indication indicates whether to perform statistics and reporting of the discard usage of the PDU set; and the charging correction indication may be sent by SMF or UPF, or configured by OAM, or locally configured by RAN.

The technical solutions in the embodiments of the present disclosure can support charging correction in PDU set scenarios, achieving accurate charging.

The enhanced charging by the RAN in PDU set QoS processing scenarios is supported, enabling accurate charging for downlink data flows of XR-related services. For example, it resolves the problem of inaccurate charging caused by the RAN actively discarding data sets based on their QoS characteristics and related information after the UPF performs charging statistics and reporting.

An embodiment of the present disclosure provides a method for determining a PDU set usage, which may be specifically as follows.

A PDU set QoS parameter and/or PDU set information is sent to an RAN node (also referred to as RAN). Based on the received PDU set QoS parameter and/or PDU set information, the RAN performs PDU set related discard data statistics and reports the statistical discard usage to a UPF for the UPF to perform charging correction.

When the PDU set QoS parameter includes PSIHI for the PDU set indicating that all PDUs in the PDU set are required, if the RAN discards the entire PDU set, the RAN performs usage statistics on the PDU set size.

When the PDU set information includes the PDU set size in bytes, if the entire PDU set is discarded, the RAN directly performs statistics on the PDU set size data in the PDU set information, as the discard usage.

The PDU set QoS parameter is sent from the control plane to the RAN; further, the PDU set QoS parameter is sent by the SMF to the RAN, for example, the SMF sends the PDU set QoS parameter to the RAN through the AMF.

The PDU set information is sent from the user plane to the RAN. For example, the PDU set information is sent by the UPF to the RAN.

For the PDU set QoS parameter, the PCF determines the PDU set QoS parameter based on information provided by the AF and/or local configuration. The PCF includes the PDU set QoS parameter in the PCC rule and sends it to the SMF.

The SMF sends the PDU set QoS parameter as part of the QoS configuration (NG-RAN as part of the QoS Profile) to the RAN node for the RAN node to perform PDU set QoS processing.

For example, the PDU set QOS parameter, especially the PSIHI of the PDU set, is provided by the AF to the PCF in a session that meets the QoS requirements.

For the PDU set information, the UPF identifies the PDU set information of the downlink flow. The UPF identifies and generates the PDU set information based on the flow information, RTP/SRTP protocol header, or specific implementation.

Furthermore, the PDU set information, especially the PDU set size in bytes, is carried to the UPF in the protocol header, extension header, or payload. For example, the PDU set information may be carried in the GPTU protocol header and provided to the RAN.

Optionally, the RAN performs statistics and reporting on PDU set related discard usage according to the charging correction indication. This charging correction indication indicates whether to perform PDU set discard usage statistics and reporting.

The charging correction indication may be sent by the SMF or UPF, or configured by OAM, or locally configured by the RAN.

Optionally, performing the charging correction of the PDU set discard usage by the RAN also includes: the RAN sends one or more PDUs in the discarded PDU set to the UPF, carrying the PDU set size in bytes and a discard mark. The UPF discounts the usage of the discarded PDU set size, obtaining more accurate usage statistics.

As shown in FIG. 11, an embodiment of the present disclosure provides an information processing apparatus, and the apparatus includes:
a determination module 110, configured to determine a discard situation of a PDU set; and
a first sending module 120, configured to send discard information of the PDU set to a UPF according to the discard situation, where the discard information indicates a discard usage of the PDU set.

The information processing apparatus may be an RAN node. The RAN node may be various types of base stations.

In some embodiments, the determination module 110 and the first sending module 120 may be program modules, which can implement the above operations after being performed by a processor.

In some other embodiments, the determination module 110 and the first sending module 120 may be software and hardware combined modules; the software and hardware combined modules include but are not limited to various programmable arrays, which include but are not limited to field programmable arrays and/or complex programmable arrays.

In some other embodiments, the determination module 110 and the first sending module 120 may be pure hardware modules; the pure hardware modules include but are not limited to application specific integrated circuits.

It can be understood that determining the discard situation of the protocol data unit (PDU) set includes:
performing statistics on the discard usage of the PDU set according to at least one of a PDU set Quality of Service (QoS) parameter, PDU set information, and correction indication.

It can be understood that the PDU set QoS parameter includes at least one of the following:
PDU Set Integrated Handling Information (PSIHI), indicating whether all PDUs in the PDU set need to be received by a receiver side;
PDU Set Error Rate (PSER), indicating an upper limit of a proportion of reception failure in the PDU set; or
PDU Set Delay Budget (PSDB), indicating a difference in time of arriving at the receiver end between the first PDU and the end PDU in the PDU set.

It can be understood that the PDU set information includes at least one of the following:
a PDU set sequence number;
indication of an end PDU of the PDU set;
a PDU sequence number in the PDU set;
a PDU set size in bytes; or
importance information of the PDU set.

It can be understood that the determination module 110 is configured to perform at least one of the following:
when the PDU set QoS parameter includes the PSIHI indicating that all PDUs in the PDU set need to be received by the receiver side, determining the discard information of the PDU set;
when the PDU set information includes the PDU set size in bytes, determining the discard information of the PDU set; or
when the correction indication is obtained, determining the discard information of the PDU set.

It can be understood that the determination module 110 is configured to determine the discard usage of the PDU set according to the PDU set size in bytes in the PDU set information.

It can be understood that the apparatus further includes a receiving module, and the receiving module is configured to receive a PDU set QoS parameter sent by a Session Management Function (SMF) through an Access Management Function (AMF); and/or receive the PDU set information sent by the UPF.

It can be understood that the apparatus further includes an obtaining module, and the obtaining module is configured to receive correction indication sent by the SMF, UPF or a Policy Control Unit (PCF); or obtain the correction indication locally configured by the RAN node or configured by an Operation Administration and Maintenance (OAMF) node.

It can be understood that the first sending module 120 is configured to send one or more PDUs in the discarded PDU set to the UPF, the PDU(s) carrying the size in bytes of the discarded PDU set and/or a discard mark; or to send a discard report containing the discard usage to the UPF.

It can be understood that the determination module 110 is further configured to determine the discarded PDU set and determine a discard usage of the PDU set.

Correspondingly, the first sending module 120 is configured to send one or more PDUs in the discarded PDU set to the UPF, the PDU(s) carrying the discard usage; or to send a discard report containing the discard usage to the UPF.

It can be understood that the discard usage may include the PDU set size in bytes of the discarded PDU set.

Optionally, the one or more PDU sets sent to the UPF also carry a discard mark.

It can be understood that the determining module 110 is further configured to determine the discarded PDU set.

Correspondingly, the first sending module 110 is further configured to send one or more PDUs in the discarded PDU set to the UPF, where the PDU(s) carries a discard mark.

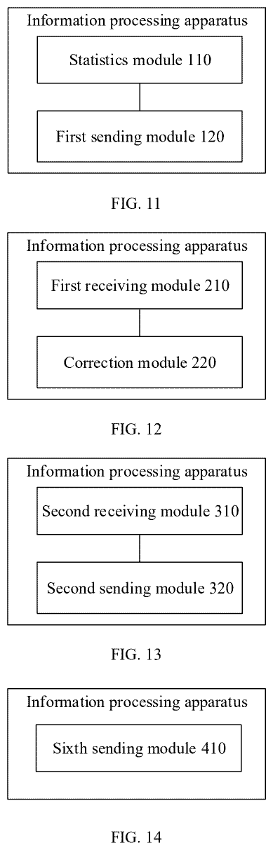

As shown in FIG. 12, an embodiment of the present disclosure provides an information processing apparatus, and the apparatus further includes:
a first receiving module 210, configured to receive discard information sent by a Radio Access Network (RAN) node; where the discard information indicates a discard usage of a PDU set; and
a correction module 220, configured to correct a usage of a Quality of Service (QOS) flow to which the PDU set belongs according to the discard information.

The information processing apparatus can be a UPF.

In some embodiments, the first receiving module 210 and the correction module 220 may be program modules; and the program modules can implement the above operations after being executed by a processor.

In some other embodiments, the first receiving module 210 and the correction module 220 may be software and hardware combined modules; the software and hardware combined modules include but are not limited to various programmable arrays, which include but are not limited to field programmable arrays and/or complex programmable arrays.

In some further embodiments, the first receiving module 210 and the correction module 220 may be pure hardware modules, and the pure hardware modules include but are not limited to application specific integrated circuits.

It can be understood that the apparatus further includes a sending module.

The sending module is configured to send PDU set information to the RAN node, where the PDU set information is used by the RAN node to perform statistics on the discard usage; or is configured to send correction indication to the RAN node, where the correction indication is used by the RAN node to perform statistics on the discard usage.

It can be understood that the PDU set information includes at least one of the following:
a PDU set sequence number;
indication of an end PDU of the PDU set;
a PDU sequence number in the PDU set;
a PDU set size in bytes; or
importance information of the PDU set.

It is understood that the apparatus further includes:
a first determining module, configured to determine PDU set information according to flow information of the PDU set or one or more PDUs in the PDU set.

It can be understood that the PDU set information is carried in a protocol header, extension header or payload of the PDU.

It can be understood that the first receiving module 210 is further configured to receive correction indication from a Policy Control Function (PCF).

It is understood that the apparatus further includes:
a QoS parameter module, configured to receive a PDU set Quality of Service (QoS) parameter.

It is understood that the apparatus further includes:
a second determining module, configured to determine, according to the PDU set Quality of Service (QoS) parameter, the PDU set information and/or the correction indication, whether to correct the usage of the QoS flow to which the PDU set belongs.

As shown in FIG. 13, an embodiment of the present disclosure provides an information processing apparatus, and the apparatus includes:
a second receiving module 310, configured to receive a Policy and Charging Control (PCC) rule sent by a Policy Control Function (PCF); and
a second sending module 320, configured to send a PDU set Quality of Service (QoS) parameter and/or correction indication to a Radio Access Network (RAN) node according to the PCC rule, where the correction indication is used for the Radio Access Network (RAN) node to perform an operation related to a discard usage of the PDU set, and the PDU set QoS parameter and/or the correction indication is used for the RAN node to perform an operation related to the discard usage of the PDU set.

The information processing apparatus may include an SMF.

In some embodiments, the second receiving module 310 and the second sending module 320 may be program modules; and the program modules can implement the above operations after being executed by a processor.

In some other embodiments, the second receiving module 310 and the second sending module 320 may be software and hardware combined modules; the software and hardware combined modules include but are not limited to various programmable arrays, which include but are not limited to field programmable arrays and/or complex programmable arrays.

In some other embodiments, the second receiving module 310 and the second sending module 320 may be pure hardware modules, and the pure hardware modules include but are not limited to application specific integrated circuits.

It can be understood that the PDU set QoS parameter includes at least one of the following:
PDU Set Integrated Handling Information (PSIHI), indicating whether all PDUs in the PDU set need to be received by a receiver side;
PDU Set Error Rate (PSER), indicating an upper limit of a proportion of reception failure in the PDU set; or
PDU Set Delay Budget (PSDB), indicating a difference in time of arriving at the receiver end between the first PDU and the end PDU in the PDU set.

As shown in FIG. 14, an embodiment of the present disclosure provides an information processing apparatus, and the apparatus includes:
a sixth sending module 410, configured to send correction indication to a Radio Access Network (RAN) node, where the correction indication is used for the RAN node to perform an operation related to a discard usage of a PDU set.

The information processing apparatus may be a PCF.

In some embodiments, the sixth sending module 410 may be a program module; and the program module can implement the above operations after being executed by a processor.

In some other embodiments, the sixth sending module 410 may be a software and hardware combined module; the software and hardware combined module includes but is not limited to a programmable array; the programmable array includes but is not limited to a field programmable array and/or a complex programmable array.

In some other embodiments, the sixth sending module 410 may be a pure hardware module; and the pure hardware module includes but is not limited to an application specific integrated circuit.

The information processing apparatus in the embodiment of the present disclosure further includes a storage module, and the storage module is connected to the sixth sending module 410 and is configured to store the correction indication, etc.

It can be understood that sending the correction indication to the Radio Access Network (RAN) node includes:
sending the correction indication to the RAN node according to flow information sent by an Application Function (AF), the local configuration of the PCF and/or an operator policy.

It can be understood that the flow information includes at least one of the following:
PDU set related assistance information; or
QoS configuration.

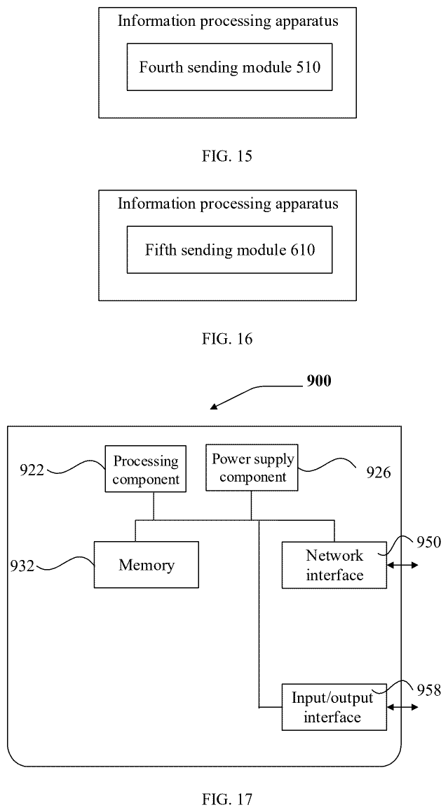

As shown in FIG. 15, an embodiment of the present disclosure provides an information processing apparatus, and the apparatus includes:
a fourth sending module 510, configured to send flow information to a Policy Control Function (PCF); where the flow information is used by the Policy Control Function (PCF) to generate a PCC rule or correction indication; the PCC rule is used for a Session Management Function (SMF) to generate a Protocol Data Unit (PDU) set Quality of Service (QoS) parameter; and the PDU set QoS parameter or correction indication is used by an RAN node to perform an operation related to a discard usage of the PDU set.

The information processing apparatus may be an AF.

In some embodiments, the fourth sending module 510 may be a program module; and the program module can implement the above operations after being executed by a processor.

In some other embodiments, the fourth sending module 510 may be a software and hardware combined module; the software and hardware combined module includes but is not limited to a programmable array; and the programmable array includes but is not limited to a field programmable array and/or a complex programmable array.

In some other embodiments, the fourth sending module 510 may be a pure hardware module; and the pure hardware module includes but is not limited to an application specific integrated circuit.

The information processing apparatus in the embodiment of the present disclosure further includes a storage module; and the storage module is connected to the fourth sending module 510 and is configured to store flow information, etc.

In some embodiments, the flow information includes at least one of the following:
PDU set related assistance information; or
QoS configuration.

As shown in FIG. 16, an embodiment of the present disclosure provides an information processing apparatus, and the apparatus includes:
a fifth sending module 610, configured to send a service data flow to a User Plane Function (UPF); where the service data flow includes Protocol Data Unit (PDU) set information and/or the service data flow includes flow information for determining the PDU set information; and the PDU set information is used for a Radio Access Network (RAN) node to perform an operation related to a discard usage of the PDU set.

The information processing apparatus may be an AF.

In some embodiments, the fifth sending module 610 may be a program module; and the program module can implement the above operations after being executed by a processor.

In some other embodiments, the fifth sending module 610 may be a software and hardware combined module; the software and hardware combined module includes but is not limited to a programmable array; and the programmable array includes but is not limited to a field programmable array and/or a complex programmable array.

In some other embodiments, the fifth sending module 610 may be a pure hardware module; and the pure hardware module includes but is not limited to an application specific integrated circuit.

The information processing apparatus in the embodiment of the present disclosure further includes a storage module; and the storage module is connected to the fifth sending module and is configured to store the service data flow, etc.

It can be understood that the PDU set information and/or flow information is carried in a protocol header, an extension header or a payload of one or more PDUs of the QoS flow.

It can be understood that the PDU set information includes at least one of the following:
a PDU set sequence number;
indication of an end PDU of the PDU set;
a PDU sequence number in the PDU set;
a PDU set size in bytes; or
importance information of the PDU set.

An embodiment of the present disclosure provides a wireless communication system, including:
an RAN node, configured to at least determine a discard situation of a PDU set; and send discard information of the PDU set to a User Plane Function (UPF) based on the discard situation, where the discard information indicates a discard usage of the PDU set; and
a UPF, configured to receive the discard information and correct a usage of a Quality of Service (QoS) flow to which the PDU set belongs according to the discard information.

In some embodiments, the wireless communication system further includes: a PCF and an SMF.

The PCF is configured to generate a PCC rule according to flow information provided by an AF, local configuration, and/or an operator policy.

The SMF is configured to receive the PCC rule generated by the PCF, extract a PDU set QoS parameter from the PCC rule, and send the PDU set QoS parameter to the RAN node, where the PDU set QoS parameter is used by the RAN node to determine the discard situation of the PDU set and send the discard information to the UPF.

In some other embodiments, the wireless communication system further includes: an AF or an AS.

The UPF is further configured to receive flow information or one or more PDUs from the AF or AS; extract PDU set information from the flow information or the one or more PDUs, and send the PDU set information to the RAN node.

The RAN node is further configured to determine, according to the PDU set information, whether to perform determination on the discard situation of the PDU set. If it is determined to perform determination on the discard situation, it sends the discard information to the UPF based on the discard situation.

In some other embodiments, the wireless communication further includes: a PCF and/or a SMF.

The PCF and/or SMF is configured to generate correction indication and send the correction indication to the RAN node.

In some other embodiments, the UPF is further configured to generate the correction indication.

In still some other embodiments, the RAN node generates the correction indication.

The correction indication involved in any of the above embodiments is used by the RAN node to determine to perform an operation related to the discard usage of the PDU set. An embodiment of the present disclosure provides a communication device, including:
a memory, configured to store processor-executable instructions; and
a processor, respectively connected to the memory.

The processor is configured to perform the information processing method provided by any of the aforementioned technical solutions.

The processor may include various types of storage media, which are non-transitory computer storage media that can continue to memorize information stored thereon after the communication device loses power.

Here, the communication device includes: a network node. The network node may include an RAN node, a UPF, a PCF, an AMF, a SMF and/or an AF, etc.

The processor can be connected to the memory through a bus, etc., and is configured to read the executable program stored in the memory, for example, at least one of the methods shown in FIGS. 2A to 2H, FIGS. 3A to 3E, FIG. 4, FIGS. 5A to 5B, FIGS. 6A to 6B, FIGS. 7 to 8, FIGS. 9A to 9D, or FIGS. 10A to 10B.

In an illustrative embodiment, it further provides a non-transitory computer-readable storage medium including instructions, such as a memory including instructions. The instructions are executable by a processor to generate the above methods. For example, the non-transitory computer-readable storage medium may be a ROM, a random access memory (RAM), a CD-ROM, a magnetic tape, a floppy disk, an optical data storage device, etc., and may perform at least one of the methods shown in FIGS. 2A to 2H, FIGS. 3A to 3E, FIG. 4, FIGS. 5A to 5B, FIGS. 6A to 6B, FIGS. 7 to 8, FIGS. 9A to 9D, or FIGS. 10A to 10B, for example.

As shown in FIG. 17, an embodiment of the present disclosure illustrates the structure of an access device. For example, the electronic device may be provided as a network side device. The communication device may be various network elements such as the aforementioned access network elements and/or network functions.

Referring to FIG. 17, the electronic device includes a processing component 922, which further includes one or more processors, and memory resources represented by a memory 932 configured to store instructions executable by the processing component 922, such as applications. The applications stored in the memory 932 may include one or more modules, each of which corresponds to a set of instructions. In addition, the processing component 922 is configured to execute instructions to perform any of the aforementioned methods applied to the access device, such as at least one of the methods shown in FIG. 2A to FIG. 2H, FIG. 3A to FIG. 3E, FIG. 4, FIG. 5A to FIG. 5B, FIG. 6A to FIG. 6B, FIG. 7 to FIG. 8, FIG. 9A to FIG. 9D, or FIG. 10A to FIG. 10B.

The electronic device may further include a power supply component 926 configured to perform power management of the electronic device, a wired or wireless network interface 950 configured to connect the electronic device to a network, and an input/output (I/O) interface 958. The electronic device may operate based on an operating system stored in the memory 932, such as Windows Server ™, Mac OS X™, Unix™, Linux™, FreeBSD™ or the like.

According to the technical solutions provided by the embodiments of the present disclosure, the RAN node determines the discard situation of the PDU set and provide the discard information reflecting the discard situation to the UPF. As such, the UPF can determine the discard usage based on the discard information, and the discard usage can be used for usage statistics or charging correction of service data flows, UEs or user accounts, thereby improving accuracy of the usage statistics and charging.

Under the condition of no contradiction, each step in a certain implementation or embodiment can be implemented as an independent embodiment, and the steps can be arbitrarily combined. For example, a solution after removing some steps in a certain implementation or embodiment can also be implemented as an independent embodiment, and the order of the steps in a certain implementation or embodiment can be arbitrarily exchanged. In addition, the optional methods or optional instances in a certain implementation or embodiment can be arbitrarily combined; in addition, the various embodiments or examples can be arbitrarily combined. For example, some or all steps of different embodiments or examples can be arbitrarily combined, and a certain implementation or embodiment can be arbitrarily combined with the optional methods or optional instances of other implementations or embodiments.

Those skilled in the art can readily conceive of other implementations of the embodiments of the present disclosure after considering the specification and practicing the disclosure disclosed herein. The present disclosure is intended to cover any variations, uses, or adaptations of the embodiments of the present disclosure that follow the general principles of the embodiments of the present disclosure and include common knowledge or customary technical measures in the art that are not disclosed herein. The specification and embodiments are to be considered as illustrative only, with the true scope and spirit of the embodiments of the present disclosure being indicated by the following claims.

It should be understood that the embodiments of the present disclosure are not limited to the precise structures described above and shown in the drawings, and various modifications and changes can be made without departing from the scope thereof. The scope of the embodiments of the present disclosure is limited only by the appended claims.

1. An information processing method, the method being performed by a Radio Access Network (RAN) node and comprising:
determining a discard situation of a Protocol Data Unit (PDU) set; and
sending, according to the discard situation, discard information of the PDU set to a User Plane Function (UPF), wherein the discard information indicates a discard usage of the PDU set.

2. The method according to claim 1, wherein the determining the discard situation of the protocol data unit (PDU) set comprises:
determining the discard situation of the PDU set according to at least one of a PDU set Quality of Service (QoS) parameter, PDU set information, or correction indication.

3. The method according to claim 2, wherein the PDU set QoS parameter comprises at least one of:
PDU Set Integrated Handling Information (PSIHI), indicating whether all PDUs in the PDU set need to be received by a receiver side;
PDU Set Error Rate (PSER), indicating an upper limit of a proportion of reception failure in the PDU set; or
PDU Set Delay Budget (PSDB), indicating a difference in time of arriving at the receiver side between a first PDU and an end PDU in the PDU set.

4. The method according to claim 2, wherein the PDU set information includes at least one of:
a PDU set sequence number;
indication of an end PDU of the PDU set;
a PDU sequence number in the PDU set;
a PDU set size in bytes; or
importance information of the PDU set.

5. The method according to claim 3, wherein the determining the discard situation of the protocol data unit (PDU) set according to the at least one of the PDU set Quality of Service (QoS) parameter, the PDU set information, or the correction indication comprises at least one of:
in a case where the PDU set QoS parameter comprises the PSIHI indicating that all PDUs in the PDU set need to be received by the receiver side, determining the discard situation of the PDU set;
in a case where the PDU set information comprises the PDU set size in bytes, determining the discard situation of the PDU set; or
in a case where the correction indication is obtained, determining the discard situation of the PDU set.

6. The method according to claim 1, wherein before determining the discard situation of the PDU set, the method further comprises at least one of:
receiving a PDU set QoS parameter sent by a Session Management Function (SMF) through an Access Management Function (AMF); or,
receiving PDU set information sent by the UPF.

7. The method according to claim 1, further comprising:
receiving the correction indication sent by a SMF, the UPF or a Policy Control Unit Function (PCF); or,
obtaining the correction indication that is locally configured by the RAN node or configured by an Operation Administration and Maintenance (OAM) node.

8. The method according to claim 1, wherein the determining the discard situation of the Protocol Data Unit (PDU) set comprises:
performing statistics on the discard usage of a discarded PDU set.

9. The method according to claim 1, wherein the sending, according to the discard situation, the discard information of the PDU set to the User Plane Function (UPF) comprises at least one of:
sending one or more PDUs in a discarded PDU set to the UPF, wherein the one or more PDUs carry the discard usage;
sending one or more PDUs in the discarded PDU set to the UPF, wherein the one or more PDUs carry a discard mark; or
sending a discard report comprising the discard usage to the UPF.

10. The method according to claim 9, wherein:
the discard usage comprises: a PDU set size in bytes of the discarded PDU set.

11. An information processing method, the method being performed by a User Plane Function (UPF) and comprising:
receiving discard information sent by a Radio Access Network (RAN) node, wherein the discard information indicates a discard usage of a Protocol Data Unit (PDU) set; and
correcting, according to the discard information, a usage of a Quality of Service (QoS) flow to which the PDU set belongs.

12. The method according to claim 11, wherein before receiving the discard information, the method further comprises:
sending PDU set information to the RAN node, wherein the PDU set information is used for the RAN node to perform statistics on the discard usage; or,
sending correction indication to the RAN node, wherein the correction indication is used for the RAN node to perform statistics on the discard usage.

13. (canceled)

14. The method according to claim 11, further comprising:
determining the PDU set information according to flow information of the PDU set or one or more PDUs in the PDU set.

15. The method according to claim 14, wherein the PDU set information is carried in a protocol header, an extension header or a payload of the PDU.

16. The method according to claim 12, further comprising:
receiving correction indication from a Policy Control Function (PCF), or
receiving a PDU set Quality of Service (QoS) parameter.

17. (canceled)

18. The method according to claim 11, further comprising:
determining, according to at least one of a QoS parameter of the PDU set, PDU set information or correction indication, whether to correct the usage of the QoS flow to which the PDU set belongs.

19. An information processing method, the method being performed by a Session Management Function (SMF) and comprising:
receiving a Policy and Charging Control (PCC) rule sent by a Policy Control Function (PCF); and
sending at least one of a PDU set Quality of Service (QoS) parameter and/or correction indication to a Radio Access Network (RAN) node according to the PCC rule, wherein the at least one of the PDU set QoS parameter and/or the correction indication is used for the RAN node to perform an operation related to a discard usage of a PDU set.

20.-40. (canceled)

41. A communication device comprising:
a processor; and
a memory, and configured to store instructions executable by the processor executable,
wherein the processor is configured to performs the information processing method according to claim 1.

42.-43. (canceled)

44. A communication device comprising:
a processor; and
a memory, configured to store instructions executable by the processor,
wherein the processor it is configured to perform the information processing method according to claim 11.

45. A communication device comprising:
a processor; and
a memory, configured to store instructions executable by the processor,
wherein the processor it is configured to perform the information processing method according to claim 19.
